(19) United States
(12) Patent Application Publication
(10) Pub. No.: US 2018/0020669 A1
(43) Pub. Date: Jan. 25, 2018

(54) Methods for the Inhibition and Dispersal of Biofilms

(71) Applicant: Auspherix Limited, Stevenage, Hertfordshire (GB)

(72) Inventors: Ian Charles, Stevenage, Hertfordshire (GB); Alber Dagmar, Stevenage, Hertfordshire (GB)

(21) Appl. No.: 15/549,369

(22) PCT Filed: Feb. 4, 2016
(86) PCT No.: PCT/GB2016/050264

§ 371 Date: Aug. 7, 2017

(30) Foreign Application Priority Data
Feb. 6, 2015 (AU) 2015900377

(51) Int. Cl. A01N 59/16; A01N 63/04; A01N 43/90; A01N 57/18; A01N 43/16; A01N 43/60

(52) U.S. Cl. CPC A01N 59/16; A01N 43/16; A01N 43/60; A01N 43/90; A01N 57/18; A01N 63/04

(57) ABSTRACT

The present disclosure relates to methods for inhibiting microbial growth, inhibiting biofilm formation or development, disrupting existing biofilms, reducing the biomass of a biofilm, and methods for sensitizing a biofilm and microorganisms with the biofilm to an antimicrobial agent.

### FIELD

Embodiments of the present invention relate generally to methods for inhibiting microbial growth, inhibiting biofilm formation or development, disrupting existing biofilms, reducing the biomass of a biofilm, and methods for sensitizing a biofilm and microorganisms with the biofilm to an antimicrobial agent.

### BACKGROUND

Biofilms are aggregates of microorganisms in which the microbial cells adhere to each other on a surface or at an interface where water or suitable fluid is available, or in suspension, producing a matrix. Biofilms form following population of a surface or an interface, such as a solid-liquid surface or an air-liquid surface, by individual cells. Subsequent production of extracellular polymeric substances and cell adhesion molecules promote adhesion of the microorganisms to the surface and each other. Following this attachment phase is an intermediate phase in which irreversibly attached cells aggregate into microcolonies or cell clusters on the surface. The biofilm architecture develops and matures through a combination of cell division and recruitment to a structurally heterogeneous form with genetic diversity, held together by a matrix that includes polysaccharides, proteins and extracellular nucleic acid. Within the biofilm, microorganisms may communicate with one another using a process known as quorum sensing. This process regulates biofilm formation in bacteria such as staphylococci, streptococci, and enterococci. Various mechanisms then result in release of microorganisms from the biofilm, and these detached microbial cells return to a planktonic mode of growth.

Biofilms have been implicated in a number of human infections, including, for example, endocarditis, osteomyelitis, chronic otitis media, foreign-body-associated infections, gastrointestinal ulcers, urinary tract infections, Legionnaire's disease, chronic lung infections in cystic fibrosis patients, caries and periodontitis. Biofilms can form on a variety of surfaces within the body, such as, for example, on surfaces in the respiratory tract and lungs (such as associated with pulmonary infections in subjects with cystic fibrosis), in bone (such as associated with osteomyelitis), and on surfaces of the heart and heart valves (such as associated with endocarditis). Biofilms also readily form on medical equipment such as catheters and cannulas, and on implantable medical devices including stents. Because of the virulent nature of some of the microorganisms that form biofilms on medical devices, such as Staphylococcus spp. (for example Staphylococcus aureus), device removal is often recommended, resulting in significant increases in cost and hospitalization times, as well as an increased risk to the patient. Biofilms are also important reservoirs of pathogens in water systems such as drinking water, reservoirs, pipes and air-conditioning ducts. Biofilms also cause significant industrial damage, causing, for example, fouling and corrosion in fluid processes such as water distribution and treatment systems, pulp and paper manufacturing systems, heat exchange systems and cooling towers, and contributing to the souring of oil in pipelines and reservoirs.

Biofilms offer increased protection to the microorganism inhabitants, for example in the form of substantially increased resistance of the microorganisms within the biofilm to antimicrobials (up to 1000-fold) and host immune responses compared to planktonic cells. This explains the severity and high level of persistence of biofilms and the morbidity associated with infections produced by biofilms.

Many microorganisms of clinical importance form biofilms. Non-limiting examples of bacteria that form biofilms include Gram positive bacteria such as Staphylococcus spp., Streptococcus spp., Enterococcus spp., Listeria spp. and Clostridium spp., and Gram negative bacteria such as Klebsiella spp., Acinetobacter spp., Pseudomonas spp., Burkholderia spp., Erwinia spp., Haemophilus spp., Neisseria spp., Escherichia spp, Vibrio spp. and Actinobacillus spp. Lower eukaryotes such as yeast and filamentous fungi (e.g. Candida spp., Pneumocystis spp., Coccidioides spp., Aspergillus spp., Zygomycetes spp., Blastoschizomyces spp., Saccharomyces spp., Malassezia spp., Trichosporon spp., and Cryptococcus spp.) also form biofilms.

Klebsiella pneumoniae is a Gram-negative pathogen that is becoming increasingly important as a cause of nosocomial infections. K. pneumoniae causes, for example, urinary tract and respiratory infections and readily forms biofilms on medical devices such as catheters and respiratory support equipment. Multi-drug resistant (MDR) K. pneumoniae are also of major clinical concern and appear to be increasing in prevalence. Carbapenem-resistant K. pneumoniae (CRKP) is resistant to almost all antimicrobial agents and infection with CRKP causes particularly high rates of mortality and morbidity.

S. aureus and Staphylococcus epidermidis are Gram positive opportunistic pathogens that account for approximately 30% of all healthcare associated infections. Most S. aureus infections are resistant to first-line antibiotics. Methicillin-resistant S. aureus (MRSA) is resistant to beta-lactams, including methicillin and other more common antibiotics such as oxacillin, penicillin, and amoxicillin. It has been estimated that the annual cost of treating MRSA in hospitalized patients is between $3.4-4.2 billion.

One of the reasons that staphylococci are the cause of so many infections is their ability to form biofilms. S. aureus is particularly effective at colonizing host tissue to cause endocarditis and osteomyelitis, but also forms biofilms on medical devices and is a common cause of foreign-body associated infections. While S. aureus typically causes more acute infections, S. epidermidis generally causes subacute or chronic infections. S. epidermidis is a leading cause of foreign-body associated infections, although is also known to cause endocarditis. These diseases can be complicated still further by the dispersal of bacteria from the biofilm, which can then be disseminated through the blood to cause sepsis.

The large cost, both in monetary terms and in terms of the health of patients, of infections, diseases and conditions associated with biofilms means that there is a need for improved methods for preventing, inhibiting and treating the biofilms, as well as a need for increasing the sensitivity of biofilms to antimicrobial agents.

### SUMMARY

The present disclosure is directed generally to methods for inhibiting microbial growth, inhibiting biofilm formation or development, disrupting existing biofilms, reducing the biomass of a biofilm, and methods for sensitizing a biofilm and microorganisms with the biofilm to an antimicrobial agent. The methods described herein may be performed, for example, in vivo, ex vivo, or in vitro.

The present disclosure provides a method for reducing the biomass of a biofilm and/or promoting the dispersal of microorganisms from a biofilm, comprising exposing the biofilm to an effective amount of auranofin.

The present disclosure also provides a method for dispersing, removing, or eliminating a biofilm, comprising exposing the biofilm to an effective amount of auranofin. In some embodiments the biofilm is an existing, preformed or established biofilm.

The present disclosure further provides a method for killing microorganisms within a biofilm, comprising exposing the biofilm to an effective amount of auranofin. In some embodiments the biofilm is an existing, preformed or established biofilm.

In some aspects, the biofilm comprises bacteria, such as, for example, multi-drug resistant bacteria. In some aspects the bacteria are Gram positive bacteria. In some aspects the bacteria are Gram negative bacteria. In particular examples, the biofilm comprises, consists essentially of, or consists of S. aureus. In some aspects, the S. aureus is methicillin-resistant S. aureus (MRSA). In some embodiments, the biofilm comprises, consists essentially of, or consists of A. baumannii. In other embodiments, the biofilm comprises, consists essentially of, or consists of K. pneumoniae. In further embodiments, biofilm comprises fungi, such as C. albicans and/or C. neoformans. The biofilm may be a single species biofilm or a mixed species biofilm.

In some aspects the bacteria have a thioredoxin (Trx) pathway. In some aspects the bacteria do not have a glutathione (GSH) and glutathione reductase pathway (GR). In some aspects the bacteria do not express γ-glutamate-cysteine ligase (GshA), glutathione synthetase (GshB), and/or glutathione reductase (Gor); for example, the bacteria may not express GSHA, GSHB, and/or GOR activity.

The disclosure also provides a method for inhibiting biofilm formation, comprising exposing a biofilm-forming microorganism to an effective amount of auranofin.

In some aspects of the methods for inhibiting biofilm formation, the biofilm-forming microorganism is a bacterium. In a particular example, the biofilm-forming microorganism is a multi-drug resistant bacterium. In some aspects of the method, the biofilm-forming microorganism is S. aureus (e.g. S. aureus is MRSA). In other aspects, the biofilm-forming microorganism is A. baumannii or K. pneumoniae. In further aspects, the biofilm-forming microorganism is a fungus, such as, for example, C. albicans or C. neoformans.

In such methods, the auranofin may be coated, impregnated or otherwise contacted with a surface or interface susceptible to biofilm formation. In some examples, the surface is a surface of medical or surgical equipment, an implantable medical device or prosthesis. In particular examples, the biofilm or biofilm-forming microorganism is on a bodily surface of a subject and exposure of the biofilm or biofilm-forming microorganism to auranofin is by administration of the auranofin to the subject. In such instances, the biofilm or biofilm-forming microorganism may be associated with an infection, disease or disorder suffered by the subject or to which the subject is susceptible. As demonstrated herein, auranofin can act synergistically with other antimicrobial agents, allowing for increased efficacy of anti-microbial action. Accordingly, for any aspect described herein comprising exposing a biofilm or biofilm-forming microorganism to auranofin, the present disclosure provides a corresponding further aspect comprising exposing the biofilm or biofilm-forming microorganism to a combination of auranofin and at least one additional antimicrobial agent, such as, for example, an antibiotic or an anti-fungal agent. In particular examples, the antibiotic is selected from rifampicin, gentamicin, erythromycin, lincomycin and vancomycin.

The present disclosure also provides a method of sensitizing a microorganism in a biofilm to an antimicrobial agent by exposing the biofilm to an effective amount of auranofin.

In particular embodiments of the methods of sensitizing a microorganism in a biofilm to an antimicrobial agent, the microorganism is a bacterium. For example, the microorganism may be a multi-drug resistant bacterium. In some aspects of the present disclosure, the microorganism is S. aureus. In particular examples, the S. aureus is MRSA. In other examples, the microorganism is A. baumannii or K. pneumoniae. In further embodiments, the microorganism is a fungus. For example, the microorganism may be C. albicans or C. neoformans. In some aspects of these methods, the antimicrobial agent is an antibiotic (e.g. rifampicin, gentamicin, erythromycin, lincomycin or vancomycin) or an antifungal agent.

The present disclosure is also directed to use of auranofin for the preparation of a medicament for inhibiting biofilm formation, reducing the biomass of a biofilm or promoting the dispersal of microorganisms from a biofilm.

The present disclosure is further directed to use of auranofin for the preparation of a medicament for treating or preventing an infection, disease or disorder caused by a biofilm.

The present disclosure is also directed to the use of auranofin for the preparation of a medicament for sensitizing a microorganism in a biofilm to an antimicrobial agent.

The present disclosure is also directed to auranofin for use in a method of dispersing, removing or eliminating an existing biofilm, inhibiting biofilm formation, reducing the biomass of a biofilm, promoting the dispersal of microorganisms from a biofilm, killing microorganisms within a biofilm, sensitizing a microorganism in a biofilm to an antimicrobial agent, or treating or preventing an infection, disease or disorder caused by a biofilm (see, for example, the diseases and disorders listed in paragraph [0063] herein).

The present disclosure is also directed to auranofin for use in a method of treating or preventing an infection, disease or disorder treatable by dispersing, removing or eliminating an existing biofilm, inhibiting biofilm formation, reducing the biomass of a biofilm, promoting the dispersal of microorganisms from a biofilm, killing microorganisms within a biofilm, or sensitizing a microorganism in a biofilm to an antimicrobial agent.

### BRIEF DESCRIPTION OF THE DRAWINGS

Embodiments of the disclosure are described herein, by way of non-limiting example only, with reference to the following figures.

FIG. 1 shows growth inhibition of various S. aureus strains in Cation-Adjusted Mueller-Hinton Broth (CaMHB) in the presence of various concentrations of auranofin, expressed as a percentage of the growth (as determined by absorbance at 595 nm) of the same strains in the absence of auranofin. A. Growth inhibition of S. aureus NCTC 8325. B. Growth inhibition of S. aureus clinical isolates 04-229-2455, 04-228-1825, 04-227-3567 and 02-228-3611, and hospital and community acquired MRSA strains IMVS67 (nmMRSA D), RBH98 (QLD), PAH58 (SWP), MW2 (USA400), CH16 (UK EMRSA-15) RPAH18 (Aus-2) and USA300.

FIG. 2 represents the results of a time kill assay to assess the effect of auranofin on the growth of S. aureus. The number of colony forming units (cfu)/mL was determined at various intervals during culture of S. aureus in the presence of auranofin, rifampicin, or a combination of auranofin and rifampicin (triangles, 0.5 μg/mL auranofin; filled squares, 1 μg/mL auranofin; small circles, 5 μg/mL auranofin; inverted triangles, 0.2 μg/mL rifampicin; diamonds, 1 μg/mL rifampicin; large circles, 0.5 μg/mL auranofin and rifampicin). A control in which S. aureus was cultured in the absence of either auranofin or rifampicin was also included (open squares).

FIG. 3 shows the effective treatment of S. aureus invasion of THP-1 cells with auranofin. THP-1 cells were infected with a moi=3 of S. aureus SH1000gfp for 1.5 hours prior to addition of auranofin; pt=post treatment.

FIG. 4 represents the results of a biofilm prevention assay to assess the effect of auranofin on the formation of S. aureus biofilms. Bacteria were cultured in a sealed environment (AeraSeal™) in 96 well plates in the presence or absence of auranofin. Biofilm formation was measured after 24 hours by the addition of crystal violet, which stains the biofilm attached to the plate, followed by solubilization with acetic acid and measurement of absorbance at 630 nm. The results were expressed as the percentage absorbance of the bacteria only control (i.e. bacteria grown in the absence of auranofin). A. Inhibition of biofilm formation by S. aureus NCTC 8325. B. Inhibition of biofilm formation by MRSA (RPAH18).

FIG. 5 shows the effect of auranofin on existing S. aureus biofilms. A photograph of a 96 well plate in which the assay was performed, showing biofilm stained with crystal violet in wells containing various concentrations of the compounds (cpd): auranofin alone (columns 1 and 2); auranofin and lincomycin (columns 3 and 4); auranofin and rifampicin (columns 5 and 6); and rifampicin alone (columns 7 and 8). Controls with bacteria grown with no compound (no cpd control) and no bacteria (no bac control) were also included as shown.

FIG. 6 shows the effects of auranofin on the biomass of pre-existing S. aureus biofilms, in combination with rifampicin (A and B) or gentamicin (C). In B and C, triangles represent 0 μg/mL rifampicin or gentamicin, squares represent 0.9 μg/mL rifampicin or 25 μg/mL gentamicin, and diamonds represent 3 μg/mL rifampicin or 75 μg/mL gentamicin.

FIGS. 7A & 7B shows the results of two resistance frequency assays (assay 1 [7A] and assay 2 [7B]) to assess whether auranofin-resistant S. aureus mutants developed. S. aureus grown on CaMHB agar plates containing 1×; 1.5×; 2× and 4× the minimum inhibitory concentration of auranofin. Any potential mutants were picked and analysed. S. aureus was also grown on TSA plates and disc-diffusion assays carried out under standard conditions (using 3 MM discs impregnated with either rifampicin or auranofin placed on top of the bacterial lawn). Rifampicin-resistant (rif resist) colonies were identified and isolated growing within the rifampicin zone of inhibition and putative auranofin-resistant (Au resist) mutants were picked from the edge of the auranofin zone of inhibition. Potential mutants were cultured in CaMHB in the presence or absence of auranofin, rifampicin or lincomycin. Control bacterial cultures that were not resistant (wt), were also included in the growth assays. The growth of the bacteria was assessed and expressed as a percentage of the control (i.e. bacteria grown in the absence of antibiotic).

FIG. 8 represents the results of a biofilm prevention assays using potential auranofin-resistant (Au resist) and potential rifampicin-resistant (rif resist) S. aureus mutants. Biofilm formation was assessed in the presence of various concentrations of auranofin (A) or rifampicin (B) and absorbance of the re-solubilized crystal violet was expressed as a percentage of the control. Circles represent potential auranofin resistant mutants; squares represent potential rifampicin resistant mutants; triangles represent potential rifampicin resistant mutants regrown; and inverted triangles represent wild-type cells cultured in the absence of auranofin or rifampicin.

FIG. 9 shows the effect of auranofin on growth of four multi-drug resistant clinical isolates of K. pneumoniae, C204742 (A, top plates), C68761 (A, bottom plates), C188681 (B, top plates) and C71173 (B, bottom plates). For each strain the left hand plates show growth inhibition in the presence of auranofin and gentamicin (100 μg each; left) and gentamicin alone (100 μg; right), while the right hand plates show growth inhibition in the presence of auranofin (100 μg).

FIG. 10 shows growth inhibition of A. baumannii strains D2, A94 and ATCC 17978 in the presence of various concentrations of auranofin (A) or gentamicin (B), expressed as a percentage of the growth of the same strains in the absence of auranofin.

FIG. 11 shows growth inhibition of A. baumannii strain D2 in the presence of various concentrations of auranofin and gentamicin, expressed as a percentage of the growth of the same strain in the absence of either antibiotic.

FIG. 12 shows the effect of auranofin on growth of three isolates of A. baumannii; D2 (top plates), A94 (middle plates), and ATCC 17978 (bottom plates). For each strain the left hand plates show growth inhibition in the presence of 4 μg (left disc) or 100 μg (right disc) auranofin, while the right hand plates show growth inhibition in the presence of 4 μg auranofin (right disc), and 100 μg gentamicin (left disc) and a combination of 4 μg auranofin and 100 μg gentamicin (bottom disc).

FIG. 13 represents the results of a biofilm prevention assay to assess the effect of auranofin (A) or gentamicin (B) on the formation of A. baumannii biofilms. Bacteria (strain D2) were cultured in an AeraSeal™-sealed environment in 96 well plates in the presence or absence of auranofin or gentamicin. Biofilm formation was measured after 24 hours by the addition of crystal violet (which adheres to the bacteria attached to the plate), followed by solubilization with acetic acid and measurement of absorbance at 630 nm. The results were expressed as the percentage absorbance of the “bacteria only” control (i.e. bacteria grown in the absence of auranofin).

FIG. 14 shows the sensitivity to auranofin of a range of redox mutants.

### DETAILED DESCRIPTION

The articles “a” and “an” are used herein to refer to one or to more than one (i.e., to at least one) of the grammatical object of the article. By way of example, “an antimicrobial agent” means one antimicrobial agent or more than one antimicrobial agent.

In the context of this specification, the term “about” is understood to refer to a range of numbers that a person of skill in the art would consider equivalent to the recited value in the context of achieving the same function or result.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

As used herein the term “containing” when used in the context of a biofilm containing particular microorganisms, means that the biofilm may comprise those microorganisms, consist essentially of those microorganisms (i.e. the microorganism in question is the predominant species or type of microorganism in the biofilm), or consist of those microorganisms (i.e. the microorganism in question is the only species or type of microorganism in the biofilm).

As used herein the term “antimicrobial agent” refers to any agent that, alone or in combination with another agent, is capable of killing or inhibiting the growth of one or more species of microorganism. Antimicrobial agents include, but are not limited to, antibiotics, antifungals, detergents, surfactants, agents that induce oxidative stress, bacteriocins and antimicrobial enzymes (e.g. lipases, pronases and lyases) and various other proteolytic enzymes and nucleases, peptides and phage. Reference to an antimicrobial agent includes reference to both natural and synthetic antimicrobial agents.

As used herein the term “biofilm” refers to any three-dimensional, matrix-encased microbial community displaying multicellular characteristics. Accordingly, as used herein, the term biofilm includes surface-associated biofilms as well as biofilms in suspension, such as flocs and granules. Biofilms may comprise a single microbial species or may be mixed species complexes, and may include bacteria as well as fungi, algae, protozoa, or other microorganisms.

The term “biofilm-forming microorganism” refers to any microorganism that is capable of forming biofilms, either single species or mixed species biofilms.

As used herein, reference to a “microorganism” includes reference to bacteria and lower eukaryotes, such as fungi, including yeasts, unicellular fungi and filamentous fungi.

As used herein the term “multi-drug resistant” means a microbial strain that displays resistance to any two or more antimicrobial agents. Typically the term refers to a bacterial strain that is resistant to multiple antimicrobial agents of different structure and/or function and belonging to different classes of drugs.

The term “reducing the biomass of a biofilm” is used herein to mean reducing the biomass of an area of a biofilm exposed to an effective amount of auranofin as compared to the biofilm biomass of the area immediately before exposure to auranofin. In some embodiments the “biomass” is the mass of cells present in the area of biofilm in addition to the extracellular polymeric substance (EPS) of the biofilm matrix. In some embodiments the “biomass” is only the mass of cells present in the area of biofilm (that is, the mass of the EPS is not counted as “biomass”). In some embodiments the biomass of the area of a biofilm exposed to an effective amount of auranofin is at least 10% less than the biofilm biomass of the area immediately before exposure to auranofin, for example, at least 20%, at least 30%, at least 40%, at least 50%, at least 60%, at least 70%, at least 80%, at least 90%, at least 95%, at least 98%, or at least 99% less than the biofilm biomass of the area immediately before exposure to auranofin. In some embodiments the area of biofilm compared is 10⁻⁶ m²; in other embodiments the area of biofilm compared is 10⁻⁵ m², 10⁻⁴ m², or 10⁻³ m². In some embodiments a biofilm whose biomass has been reduced by at least 95% is deemed to have been “eliminated”, “dispersed” or “removed”. In some embodiments a biofilm whose biomass has been reduced by at least 99% is deemed to have been “eliminated”, “dispersed” or “removed”. In some embodiments a biofilm whose biomass has been reduced by at least 99.9% is deemed to have been “eliminated”, “dispersed” or “removed”. In some embodiments the change in biofilm biomass is assessed by a method comprising the steps of: i) washing the area of biofilm to remove non-adherent (planktonic) microorganisms, ii) assessing the area of biofilm biomass (i.e. the biomass “immediately before exposure to auranofin”), iii) exposing the area of biofilm (or an otherwise identical area) to an effective amount of auranofin for a period of time (for example, 24 hours), iv) washing the biofilm to remove non-adherent (planktonic) microorganisms, and v) assessing the area of biofilm biomass to obtain the ‘post-exposure’ biomass. In some embodiments the biofilm biomass is assessed using the staining described herein in example 7.

The term “promoting the dispersal of microorganisms from a biofilm” is used herein to mean reducing the number of microorganisms present in an area of a biofilm exposed to an effective amount of auranofin as compared to the number of microorganisms present in the area immediately before exposure to auranofin. In some embodiments the number of microorganisms in the area of a biofilm exposed to an effective amount of auranofin is at least 10% less than the number of microorganisms present in the area immediately before exposure to auranofin, for example, at least 20%, at least 30%, at least 40%, at least 50%, at least 60%, at least 70%, at least 80%, at least 90%, at least 95%, at least 98%, or at least 99% less than the number of microorganisms present in the area immediately before exposure to auranofin. In some embodiments the change in number of microorganisms in an area of biofilm is assessed by a method comprising the steps of: i) washing the biofilm to remove non-adherent (planktonic) microorganisms, ii) counting the remaining microorganisms to obtain a ‘pre-exposure’ microorganism count (i.e. the count “immediately before exposure to auranofin”), iii) exposing the biofilm to an effective amount of auranofin for a period of time (for example, 24 hours), iv) washing the biofilm to remove non-adherent (planktonic) microorganisms, and v) counting the remaining microorganisms to obtain the ‘post-exposure’ microorganism count. In some embodiments a biofilm where number of microorganisms in an area has been reduced by at least 95% is deemed to have been “eliminated”, “dispersed” or “removed”. In some embodiments a biofilm where number of microorganisms in an area has been reduced by at least 99% is deemed to have been “eliminated”, “dispersed” or “removed”. In some embodiments a biofilm where number of microorganisms in an area has been reduced by at least 99.9% is deemed to have been “eliminated”. “dispersed” or “removed”.

The term “killing microorganisms within a biofilm” is used herein to mean reducing the number of live microorganisms present in an area of a biofilm exposed to an effective amount of auranofin as compared to the number of live microorganisms present in the area immediately before exposure to auranofin. In some embodiments the biofilm is an existing, preformed or established biofilm. In some embodiments the number of live microorganisms in the area of a biofilm exposed to an effective amount of auranofin is at least 10% less than the number of live microorganisms present in the area immediately before exposure to auranofin, for example, at least 20%, at least 30%, at least 40%, at least 50%, at least 60%, at least 70%, at least 80%, at least 90%, at least 95%, at least 98%, or at least 99% less than the number of live microorganisms present in the area immediately before exposure to auranofin. In some embodiments the change in number of microorganisms in an area of biofilm is assessed by a method comprising the steps of: i) washing the area biofilm to remove non-adherent (planktonic) microorganisms, ii) manually disperse the biofilm into solution (using, for example, scraping, sonication, and vortexing), iii) prepare serial dilutions, plat, and culture to estimate the number of colony forming unit (cfu) in the area of biofilm, iv) provide an otherwise identical area of biofilm and expose it to an effective amount of auranofin for a period of time (for example, 24 hours), v) manually disperse the biofilm and estimate cfu as described above to obtain the ‘post-exposure’ microorganism count.

As used herein the term “dispersal” as it relates to a biofilm and microorganisms making up a biofilm means the process of detachment and separation of cells and a return to a planktonic phenotype or behaviour of the dispersing cells.

As used herein the term “effective amount” includes within its meaning a non-toxic but sufficient amount of an agent to provide the desired effect. The exact amount required will vary from subject to subject or situation to situation depending on factors such as the species of microorganism being exposed to the agent (e.g. auranofin), the severity of the disease or disorder associated with the biofilm, the size of the biofilm, the type of surface to which the biofilm is attached, the mode of administration of the agent and so forth. Thus, it is not possible to specify an exact “effective amount”. However, for any given case, an appropriate “effective amount” may be determined by one of ordinary skill in the art using only routine experimentation.

As used herein the term “exposing” means generally bringing into contact with. Exposure of a biofilm or biofilm-forming microorganism to an agent (e.g. auranofin) includes administration of the agent to a subject harboring the microorganism or biofilm, or otherwise bringing the microorganism or biofilm into contact with the agent itself, such as by contacting a surface on which the biofilm or biofilm-forming microorganism are present with the agent. In the present disclosure the terms “exposing”, “administering” and “contacting” and variations thereof may, in some contexts, be used interchangeably.

The term “inhibiting” and variations thereof such as “inhibition” and “inhibits” as used herein in relation to microbial growth refers to any microbiocidal or microbiostatic activity of an agent (e.g. auranofin) or composition. Such inhibition may be in magnitude and/or be temporal or spatial in nature. Inhibition of the growth of a microorganism by an agent can be assessed by measuring growth of the microorganism in the presence and absence of the agent. The growth can be inhibited by the agent by at least or about 10%, 15%, 20%, 25%, 30%, 35%, 40%, 45%, 50%, 55%, 60%, 65%, 70%, 75%, 80%, 85%, 90%, 95% or more compared to the growth of the same microorganism that is not exposed to the agent.

The term “inhibiting” and variations thereof such as “inhibition” and “inhibits” as used herein in relation to biofilms means complete or partial inhibition of biofilm formation and/or development and also includes within its scope the reversal of biofilm development or processes associated with biofilm formation and/or development. Further, inhibition may be permanent or temporary. The inhibition may be to an extent (in magnitude and/or spatially), and/or for a time, sufficient to produce the desired effect. Inhibition may be prevention, retardation, reduction or otherwise hindrance of biofilm formation or development. Such inhibition may be in magnitude and/or be temporal or spatial in nature. Inhibition of the formation or development of a biofilm by auranofin can be assessed by measuring biofilm mass or microbial growth in the presence and absence of auranofin. The formation or development of a biofilm can be inhibited by auranofin by at least about 10%, 15%, 20%, 25%, 30%, 35%, 40%, 45%, 50%, 55%, 60%, 65%, 70%, 75%, 80%, 85%, 90%, 95% or more compared to the formation or development of a biofilm that is not exposed to auranofin.

As used herein the terms “sensitize” or “sensitizing” mean making a biofilm or microorganisms within a biofilm more susceptible to an antimicrobial agent. The sensitizing effect of auranofin, on a biofilm or microorganisms within the biofilm can be measured as the difference in the susceptibility of the biofilm or microorganisms (as measured by, for example, microbial growth or biomass of the biofilm) to a second antimicrobial agent with and without administration of the compound. The sensitivity of a sensitized biofilm or microorganism (for example, a biofilm or microorganism exposed to an agent such as auranofin) to a antimicrobial agent can be increased by at least about 10%, 20%, 30%, 40%, 50%, 60%, 70%, 80%, 90%, 100%, 150%, 200%, 250%, 300%, 350%, 400%, 450%, 500% or more compared to the sensitivity of an unsensitized biofilm or microorganism (i.e. a biofilm or microorganism not exposed to the agent). In some embodiments sensitizing effect of auranofin on a biofilm or microorganisms within the biofilm can be measured by the difference in Minimum Inhibitory Concentration (MIC) of a second antimicrobial administered either in combination with auranofin, or alone. For example, in some embodiments the MIC of a combination of auranofin and the second antimicrobial is at least 10% lower than the MIC of the second antimicrobial administered alone; such as at least 20% lower, at least 30% lower, at least 40% lower, at least 50% lower, at least 60% lower, at least 70% lower, at least 80% lower, at least 90% lower, at least 95% lower, at least 99% lower, or at least 99.9% lower than the MIC of the second antimicrobial administered alone. As used herein the term “surface” includes both biological surfaces and non-biological surfaces. Biological surfaces typically include surfaces both internal (such as organs, tissues, cells, bones and membranes) and external (such as skin, hair, epidermal appendages, seeds, plant foliage) to an organism. Biological surfaces also include other natural surfaces such as wood or fibre. A non-biological surface may be any artificial surface of any composition that supports the establishment and development of a biofilm. Such surfaces may be present in industrial plants and equipment, and include medical and surgical equipment and medical devices, both implantable and non-implantable. Further, for the purposes of the present disclosure, a surface may be porous (such as a membrane) or non-porous, and may be rigid or flexible.

As used herein the terms “treating”, “treatment”, “preventing” and “prevention” refer to any and all uses which remedy a condition or symptoms, prevent the establishment of an infection, condition or disease, or otherwise prevent, hinder, retard, or reverse the progression of an infection, condition or disease or other undesirable symptoms in any way whatsoever. Thus the terms “treating” and “preventing” and the like are to be considered in their broadest context. For example, treatment does not necessarily imply that a patient is treated until total recovery.

As used herein, a “subject” includes human and non-human animals, including, for example, livestock (such as cows, sheep, goats, pigs horses and goats), companion animals (such as cats and dogs) and show or performance animals (such as horses).

In part, embodiments of the present disclosure relate generally to the use of auranofin in methods for inhibiting biofilm formation or development, methods for reducing the biomass of a biofilm, methods for promoting the dispersal of microorganisms within a biofilm, and methods for sensitizing a biofilm or microorganisms within in a biofilm to antimicrobial agents, by exposing the biofilm, biofilm-forming microorganisms, or a surface that is susceptible to biofilm formation, to auranofin.

Auranofin (2,3,4,6-tetra-o-acetyl-1-thio-J-D-glucopyranosato-S-(triethylphosphine) gold, or triethylphosphine gold thioglucose tetra-acetate) is a gold derivative with a molecular weight of 678.5 and having the structure

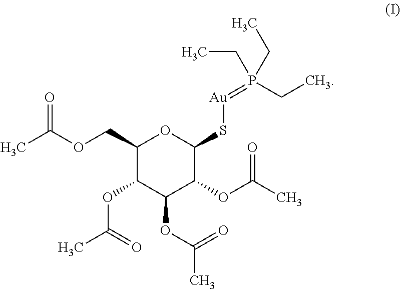

Marketed as Ridaura® auranofin is an anti-arthritic agent used in the treatment of rheumatoid and juvenile arthritis. Auranofin has been shown to inhibit leukocyte activation pathways at multiple sites, as well as inhibit the release of inflammatory mediators from human basophils, pulmonary mast cells and macrophages. Auranofin is thought to act as an anti-arthritic because of its inhibitory effect on of a number of proteases involved in the progression of rheumatoid arthritis, including its strong inhibition of the selenoenzyme thioredoxin reductase (TrxR), both in the cytosol and in the mitochondria.

More recently, auranofin has been shown to restrict the viral reservoir in HIV-infected monkeys, inhibit the growth of the parasites Trypanosona brucei and Schistosoma mansoni, and inhibit the growth of Enterococcus faecalis and Clostridium difficile. In some studies in which the anti-bacterial effect of auranofin was investigated, results indicated that auranofin blocks or disrupts selenium metabolism in these selenium-dependent organisms by forming a complex with selenium, which in turn prevents selenium-uptake and incorporation into enzymes.

As described and exemplified herein, auranofin inhibits the formation of biofilms and reduces the biomass of existing or preformed biofilms. Accordingly, provided herein are methods for inhibiting the formation or development of a biofilm. This can be achieved by exposing the biofilm-forming microorganisms to an effective amount of auranofin. Also provided are methods for reducing the biomass of a biofilm and methods for promoting the dispersal of microorganisms within a biofilm, by exposing the biofilm to an effective amount of auranofin. As demonstrated in the studies described in the Examples, exposure of the biofilm to an effective amount of auranofin can also sensitize the biofilm and microorganisms in the biofilm to antimicrobial agents that would otherwise be ineffective against the biofilm or microorganisms in the biofilm. Accordingly, also provided are methods for sensitizing microorganisms in a biofilm to an antimicrobial agent by exposing the biofilm to an effective amount of auranofin.

Without wishing to be bound by theory, it appears that Auranofin exerts its effect on persister cells at least partially through a link with impaired redox-pathway activity and enhanced oxidative stress. In particular, it appears that Auranofin inhibits the bacterial thioredoxin (Trx) pathway (see Example 9). This is consistent with Auranofin's believed mechanism of action in Rheumatoid arthritis, where it inhibits the selenoenzyme thioredoxin reductase (TrxR), both in the cytosol and in the mitochondria (ibid.).

The ability to inhibit the formation of a new biofilm and the ability to disrupt, disperse or otherwise remove an existing, preformed biofilm can be considered as distinct activities. In the former case, the targets are planktonic cells attempting to adhere to a substrate, whilst in the latter case the targets are microbial cells which are already adhered to and embedded in the biofilm matrix. These two cell populations have very different properties, most notably being substantially increased resistance (up to 1000-fold) of the microorganisms within the biofilm to antimicrobials and host immune responses compared to planktonic cells.

This increased resistance of biofilm-dwelling microorganisms to antimicrobials is particularly problematic, since most subjects presenting with biofilm-related conditions will have existing biofilms; potential toxicity to the subject and/or high cost means that it is often impossible or undesirable in a clinical setting to use very high concentrations of antimicrobials to overcome biofilm-conferred resistance. Compounds with the ability to disrupt, disperse or otherwise remove an existing, preformed biofilm at a low concentration are therefore likely to be of particular value in treating biofilm-related conditions.

Unfortunately there are few compounds known to act against existing biofilms at low concentrations. This is partly because screens for antimicrobial compounds typically assess the ability of compounds to inhibit planktonic cell growth As already noted, this activity is distinct from activity against preformed biofilms, meaning that the performance of compounds in ‘anti biofilm formation assays’ is a poor indication of a compound's activity against existing biofilms. For example, for the antimicrobial linezolid inhibition of biofilm formation is observed at ˜6 μg/ml, whereas action against existing biofilms is not observed even at 100 μg/ml MIC (that is, at least a 15-fold shift); similarly, for the antimicrobial erythromycin inhibition of biofilm formation is observed at ˜0.1-0.3 μg/ml, whereas action against existing biofilms is not observed even at 3 μg/ml MIC (that is, at least a 10 to 30-fold shift). Shifts of over 1000-fold have been observed.

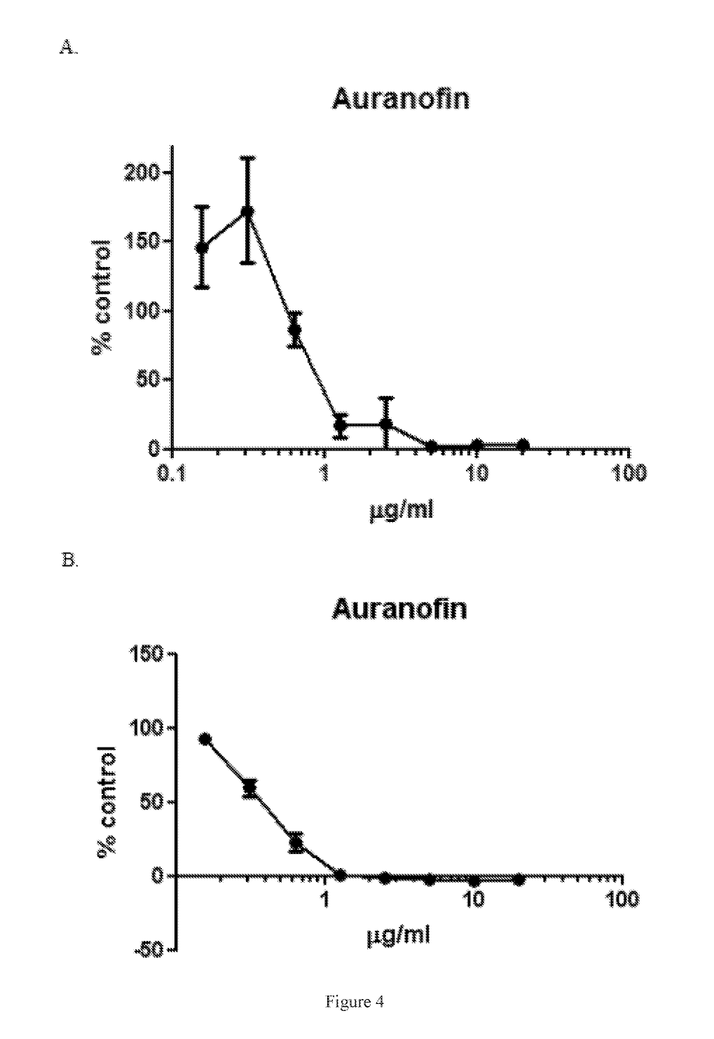

In contrast, auranofin was observed to completely inhibit biofilm formation at ˜1 μg/ml (see Example 2 and FIGS. 4A and 4B) and have action against existing biofilms at as little as 3.9 μg/ml (see Example 3); this represents a shift of less than 4-fold. Accordingly, in some embodiments the auranofin or compositions comprising auranofin disclosed herein have a shift of less than 10, such as less than 9, 8, 7, 6, 5, 4, 3, 2, or less than 1; the MIC against biofilm formation may be defined as the lowest concentration that will inhibit the formation of a biofilm by a planktonic culture after an 8 hour incubation, whilst a compound can be considered to have ‘action against existing biofilms’ when it reduces the biomass of an existing biofilm by at least 10%.

Those skilled in the art will appreciate that the methods, uses and compositions of the present disclosure are applicable to single species and mixed species biofilms that may comprise, for example, prokaryotes and/or lower eukaryotes, and any number of different species thereof. In particular embodiments, the methods, uses and compositions of the disclosure are applicable to biofilms comprising lower eukaryotes, such as yeast and filamentous fungi, including, but not limited to Candida spp., Pneumocystis spp., Coccidioides spp., Aspergillus spp. Zygomycetes spp., Blastoschizomyces spp., Saccharomyces spp., Malassezia spp., Trichosporon spp. and Cryptococcus spp. In further embodiments, the biofilms comprise bacterial species, including but not limited to, Staphylococcus spp., Streptococcus spp., Enterococcus spp., Listeria spp. and Clostridium spp., Klebsiella spp., Acinetobacter spp., Pseudomonas spp., Burkholderia spp., Erwinia spp., Haemophilus spp., Neisseria spp., Escherichia spp, Enterobacter spp., Vibrio spp. and/or Actinobacillus spp. In some examples, the biofilm comprises multi-drug resistant (MDR) bacteria (e.g. MRSA, CRKP and/or MDR A. baumannii or P. aeruginosa) and auranofin is used in accordance with the present disclosure to inhibit or prevent the formation or growth of the biofilm, reduce the biomass of the biofilm, and/or promote the dispersal of microorganisms within the biofilm, where other antimicrobial agents are ineffective. Thus, in some aspects, also provided are methods for inhibiting the growth of multi-drug resistant bacteria by exposing the bacteria to an effective amount of auranofin.

In particular embodiments, the methods, uses and compositions provided herein are applicable to biofilms comprising S. aureus, S. epidermidis, S. haemolyticus, S. caprae, S. simulans, S. hominis, S. capitis, S. saprophyticus, S. warneri, and S. lugdunensis, S. pneumoniae, S. pyogenes, S. agalactiae, S. salivarius, S. equisimilis, S. anginosus, S. sanguis, S. gordonii, S. mitis and/or S. mutans. For example, the methods and compositions provided herein are applicable to biofilms comprising, consisting of, or consisting essentially of S. aureus. In a particular example, the methods, uses and compositions provided herein are applicable to biofilms comprising, consisting of or consisting essentially of MRSA. In further non-limiting examples, the methods, uses and compositions provided herein are applicable to biofilms comprising, consisting of, or consisting essentially of K. pneumonia, A. baumannii or P. aeruginosa. For example, the methods, uses and compositions provided herein are applicable to biofilms comprising, consisting of or consisting essentially of MDR K. pneumonia and/or biofilms comprising, consisting of or consisting essentially of MDR A. baumannii. In other examples, the methods, uses and compositions provided herein are applicable to biofilms comprising, consisting of or consisting essentially of fungi such as C. albicans. C. glabrata, C. parapsilosis, C. dubliniensis, C. krusei, C. tropicalis, A. fumigatus, or C. neoforms.

The methods, uses and compositions provided herein are applicable to biofilms comprising one species of microorganism, and also to biofilms comprising two or more species of microorganism, i.e. mixed species biofilms. The mixed species biofilms may include two or more species of bacteria, two or more species of lower eukaryote (e.g. two or more fungal species, such as unicellular fungi, filamentous fungi and/or yeast), and/or both bacteria and lower eukaryotes, such as one or more species of bacteria and one or more species of lower eukaryotes. For example, the methods, uses and compositions provided herein are applicable to biofilms comprising one or more species of bacteria and one or more species of fungi, such as a yeast, unicellular fungi and/or filamentous fungi. The mixed species biofilm may thus comprise 2, 3, 4, 5, 10, 15, 20 or more species of microorganism, and the microorganisms within the biofilm may be bacteria and/or lower eukaryotes, such as unicellular fungi, filamentous fungi and/or yeast.

Exposure of the biofilm or biofilm-forming microorganisms auranofin can be achieved by any suitable method, and it is well within the skill of a skilled artisan to select the most suitable method. In some embodiments, the biofilm or biofilm-forming microorganisms are exposed to auranofin by coating, impregnating or otherwise contacting a surface or interface susceptible to biofilm formation to an effective amount of the compound. The biofilm or biofilm-forming microorganisms may already be present on the surface. In other instances, the biofilm-forming microorganisms may attach to the surface after contact of the surface with the compound. Surfaces that may be exposed to auranofin include those present in a range of industrial and domestic settings, including but not limited to, domestic, medical or industrial settings (e.g. medical and surgical devices, and surfaces within hospitals, processing plants and manufacturing plants), as well as internal and external surfaces of the body of a subject.

Thus, the methods of the present disclosure can be used for the treatment, prevention and ongoing management of infectious diseases and of conditions, diseases and disorders associated with, characterised by, or caused by biofilms and biofilm-forming microorganisms. For example, a variety of microbial infections associated with biofilm formation may be treated in accordance with methods and compositions of the present disclosure, such as cellulitis, impetigo, mastitis, otitis media, bacterial endocarditis, sepsis, toxic shock syndrome, urinary tract infections, pulmonary infections (including pulmonary infection in patients with cystic fibrosis), pneumonia, dental plaque, dental caries, periodontitis, bacterial prostatitis and infections associated with surgical procedures or burns. For example, S. aureus and S. epidermidis cause or are associated with cellulitis, impetigo, mastitis, otitis media, bacterial endocarditis, sepsis, toxic shock syndrome, urinary tract infections, pulmonary infections (including pulmonary infection in patients with cystic fibrosis), pneumonia, dental plaque, dental caries and infections associated with surgical procedures or burns. In other examples, K. pneumoniae can cause or be associated with pneumonia, sepsis, community-acquired pyogenic liver abscess (PLA), urinary tract infection, and infections associated with surgical procedures or burns. In further examples, A. baumannii can cause or be associated with bacteremia, pneumonia, meningitis, urinary tract infection, and infections associated with wounds. In still further examples, P. aeruginosa can cause or be associated with respiratory tract infections (including pneumonia), skin infections, urinary tract infections, bacteremia, infection of the ear (including otitis media, otitis externa and otitis interna), endocarditis and bone and joint infections such as osteomyelitis. Candida spp. such as C. albicans, Cryptococcus spp. such as C. neoformans, as well as other fungi such as Trichosporon spp., Malassezia spp., Blastoschizomyces spp., Coccidioides spp. and Saccharomyces spp. (e.g. S. cerevisiae) may cause or be associated with infections related to the implantation or use of medical or surgical devices, such as catheterization or implantation of heart valves. Accordingly, the methods, uses and compositions of the present disclosure are useful for the treatment or prevention of such diseases and conditions.

In particular examples, medical devices, including medical and surgical equipment and implantable medical devices, are coated, impregnated or otherwise contacted with auranofin. These medical devices include, but are not limited to, venous catheters, drainage catheters (e.g. urinary catheters), stents, pacemakers, contact lenses, hearing-aids, percutaneous glucose sensors, dialysis equipment, drug-pump related delivery cannula, prostheses such as artificial joints, implants such as breast implants, hearts, heart valves or other organs, medical fixation devices (e.g. rods, screws, pins, plates and the like), or devices for wound repair, such as sutures and wound dressings such as bandages. In a related aspect of the disclosure, a medical device (such as those exemplified above) coated or impregnated with auranofin is provided.

In other examples, auranofin is applied to a bodily surface of a subject by administration of the compound to the subject. The surface can be internal or external to the subject. For example, auranofin can be applied to the skin and/or the surfaces of the respiratory tract, lung, heart, heart valves, ear, ear canal, bone and or any other bodily surface. Administration of the auranofin to the subject in order to bring about exposure of the desired surface to auranofin (and thereby effect exposure of the biofilm and/or biofilm-forming microorganism to auranofin) can be by any route understood to be suitable by a skilled artisan. Non-limiting examples of suitable routes of administration include intranasal, oral, intraarterial, intravenous (including by discrete injection, intravenous bolus or continuous infusion), intramuscular, intradermal, transdermal, subcutaneous, intraperitoneal or topical administration (including topical administration to the eye), as well as any combination of any two or more of these routes. Auranofin can be administered to a subject once or more than once, including 2, 3, 4, 5, 6 or more times, or as many times as required to achieve the desired outcome (e.g. control of the infection), and at any appropriate interval.

In particular embodiments of the methods, auranofin is used in combination with one or more other antimicrobial agents. Accordingly, provided are methods for inhibiting the formation or development of a biofilm by exposing the biofilm-forming microorganism to an effective amount of auranofin and one or more other antimicrobial agents. Also provided are methods for reducing the biomass of a biofilm, and methods for promoting dispersal of microorganisms in a biofilm, by exposing the biofilm to an effective amount of auranofin and one or more other antimicrobial agents.

One of the reasons that biofilms are so problematic is that the microorganisms within the biofilm are particularly resistant to antimicrobial agents and host immune responses, much more so than when present as planktonic cells. As demonstrated herein, exposing a biofilm to auranofin sensitizes the biofilm and microorganisms within the biofilm to the effects of antimicrobial agents and host immune responses, so that that those antimicrobial agents and host immune responses are effective against the microorganisms within the biofilm where they would otherwise not be. Thus, for example, when a biofilm comprising S. aureus is exposed to an antibiotic such as rifampicin or gentamicin, little to no antimicrobial effect is observed. However, exposure of the biofilm to auranofin before, at the same time or after exposure of the biofilm to rifampicin or gentamicin sensitizes the biofilm and the S. aureus within the biofilm to the antimicrobial effects of rifampicin or gentamicin, such that an additive or synergistic antimicrobial effect may be observed. Accordingly, provided are methods for sensitizing the microorganisms in a biofilm to an antimicrobial agent by exposing the biofilm to an effective amount of auranofin and exposing (simultaneously or sequentially) the biofilm to the antimicrobial agent. Also provided are methods for the treatment, prevention and ongoing management of infectious diseases and of conditions, diseases and disorders associated with, characterised by, or caused by biofilms and biofilm-forming microorganisms, by administering auranofin and one or more other antimicrobial agents to a subject.

In the methods of the present disclosure that involve exposure of the biofilm and/or the biofilm-forming microorganisms to auranofin and one or more other antimicrobial agents, exposure can be at the same time or at different times, i.e. exposure can be simultaneous or sequential. Furthermore, the compound and the one or more other antimicrobial agents can be co-formulated or formulated in separate compositions. In instances where the agents are formulated in different compositions, they can be administered or delivered by the same or different routes or means. For example, where the compound and the one or more other antimicrobial agents are administered to a subject, they can be co-formulated in the same composition or formulated in different compositions and administered by the same route or different routes, e.g. by intranasal, oral, intraarterial, intravenous (including by discrete injection, intravenous bolus or continuous infusion), intramuscular, intradermal, transdermal, subcutaneous, intraperitoneal or topical administration, simultaneously or sequentially.

Exemplary antimicrobial agents suitable for the methods described herein include, but are not limited to, antibiotics, antifungals, detergents, surfactants, agents that induce oxidative stress, bacteriocins and antimicrobial enzymes (e.g. lipases, pronases and lyases) and various other proteolytic enzymes and nucleases, peptides and phage. The antimicrobial agents may be natural or synthetic. The antimicrobial agent employed may be selected for the particular application of the disclosure on a case-by-case basis, and those skilled in the art will appreciate that the scope of the present disclosure is not limited by the nature or identity of the particular antimicrobial agent.

Non-limiting examples of antimicrobial agents include fluoroquinolones, aminoglycosides, glycopeptides, lincosamides, cephalosporins and related beta-lactams, macrolides, nitroimidazoles, penicillins, polymyxins, tetracyclines, and any combination thereof. For example, the methods of the present disclosure can employ acedapsone; acetosulfone sodium; alamecin; alexidine; amdinocillin; amdinocillin pivoxil; amicycline; amifloxacin; amifloxacin mesylate; amikacin; amikacin sulfate; aminosalicylic acid; aminosalicylate sodium; amoxicillin; amphomycin; ampicillin; ampicillin sodium; apalcillin sodium; apramycin; aspartocin; astromicin sulfate; avilamycin; avoparcin; azithromycin; azlocillin; azlocillin sodium; bacampicillin hydrochloride; bacitracin; bacitracin methylene disalicylate; bacitracin zinc; bambermycins; benzoylpas calcium; berythromycin; betamicin sulfate; biapenem; biniramycin; biphenamine hydrochloride; bispyrithione magsulfex; butikacin; butirosin sulfate; capreomycin sulfate; carbadox, carbenicillin disodium; carbenicillin indanyl sodium; carbenicillin phenyl sodium; carbenicillin potassium; carumonam sodium; cefaclor; cefadroxil; cefamandole; cefamandole nafate; cefamandole sodium; cefaparole; cefatrizine; cefazaflur sodium; cefazolin; cefazolin sodium; cefbuperazone; cefdinir; cefepime; cefepime hydrochloride; cefetecol; cefixime; cefmenoxime hydrochloride; cefmetazole; cefmetazole sodium; cefonicid monosodium; cefonicid sodium; cefoperazone sodium; ceforanide; cefotaxime sodium; cefotetan; cefotetan disodium; cefotiam hydrochloride; cefoxitin; cefoxitin sodium, cefpimizole; cefpimizole sodium; cefpiramide; cefpiramide sodium; cefpirome sulfate; cefpodoxime proxetil; cefprozil; cefroxadine; cefsulodin sodium; ceftazidime; ceftibuten; ceftizoxime sodium; ceftriaxone sodium; cefuroxime; cefuroxime axetil; cefuroxime pivoxetil; cefuroxime sodium; cephacetrile sodium; cephalexin; cephalexin hydrochloride; cephaloglycin; cephaloridine; cephalothin sodium; cephapirin sodium; cephradine; cetocycline hydrochloride; cetophenicol; chloramphenicol; chloramphenicol palmitate; chloramphenicol pantothenate complex; chloramphenicol sodium succinate; chlorhexidine phosphanilate; chloroxylenol; chlortetracycline bisulfate; chlortetracycline hydrochloride; cinoxacin; ciprofloxacin; ciprofloxacin hydrochloride; cirolemycin; clarithromycin; clinafloxacin hydrochloride; clindamycin; clindamycin hydrochloride; clindamycin palmitate hydrochloride; clindamycin phosphate; clofazimine; cloxacillin benzathine; cloxacillin sodium; chlorhexidine, cloxyquin; colistimethate sodium; colistin sulfate; coumermycin; coumermycin sodium; cyclacillin; cycloserine; dalfopristin; dapsone; daptomycin; demeclocycline; demeclocycline hydrochloride; demecycline; denofungin; diaveridine; dicloxacillin; dicloxacillin sodium; dihydrostreptomycin sulfate; dipyrithione; dirithromycin; doxycycline; doxycycline calcium; doxycycline fosfatex; doxycycline hyclate; droxacin sodium; enoxacin; epicillin; epitetracycline hydrochloride; erythromycin; erythromycin acistrate; erythromycin estolate; erythromycin ethylsuccinate; erythromycin gluceptate; erythromycin lactobionate; erythromycin propionate; erythromycin stearate; ethambutol hydrochloride; ethionamide; fleroxacin; floxacillin; fludalanine; flumequine; fosfomycin; fosfomycin tromethamine; fumoxicillin; furazolium chloride; furazolium tartrate; fusidate sodium; fusidic acid; ganciclovir and ganciclovir sodium; gentamicin sulfate; gloximonam; gramicidin; haloprogin; hetacillin; hetacillin potassium; hexedine; ibafloxacin; imipenem; isoconazole; isepamicin; isoniazid; josamycin; kanamycin sulfate; kitasamycin; levofuraltadone; levopropylcillin potassium; lexithromycin; lincomycin; lincomycin hydrochloride; lomefloxacin; lomefloxacin hydrochloride; lomefloxacin mesylate; loracarbef; mafenide; meclocycline; meclocycline sulfosalicylate; megalomicin potassium phosphate; mequidox; meropenem; methacycline; methacycline hydrochloride; methenamine; methenamine hippurate; methenamine mandelate; methicillin sodium; metioprim; metronidazole hydrochloride; metronidazole phosphate; mezlocillin; mezlocillin sodium; minocycline; minocycline hydrochloride; mirincamycin hydrochloride; monensin; monensin sodiumr; nafcillin sodium; nalidixate sodium; nalidixic acid; natainycin; nebramycin; neomycin palmitate; neomycin sulfate; neomycin undecylenate; netilmicin sulfate; neutramycin; nifuiradene; nifuraldezone; nifuratel; nifuratrone; nifurdazil; nifurimide; nifiupirinol; nifurquinazol; nifurthiazole; nitrocycline; nitrofurantoin; nitromide; norfloxacin; novobiocin sodium; ofloxacin; onnetoprim; oxacillin and oxacillin sodium; oximonam; oximonam sodium; oxolinic acid; oxytetracycline; oxytetracycline calcium; oxytetracycline hydrochloride; paldimycin; parachlorophenol; paulomycin; pefloxacin; pefloxacin mesylate; penamecillin; penicillins such as penicillin G benzathine, penicillin G potassium, penicillin G procaine, penicillin G sodium, penicillin V, penicillin V benzathine, penicillin V hydrabamine, and penicillin V potassium; pentizidone sodium; phenyl aminosalicylate; piperacillin sodium; pirbenicillin sodium; piridicillin sodium; pirlimycin hydrochloride; pivampicillin hydrochloride; pivampicillin pamoate; pivampicillin probenate; polymyxin b sulfate; porfiromycin; propikacin; pyrazinamide; pyrithione zinc; quindecamine acetate; quinupristin; racephenicol; ramoplanin; ranimycin; relomycin; repromicin; rifabutin; rifametane; rifamexil; rifamide; rifampin; rifapentine; rifaximin; rolitetracycline; rolitetracycline nitrate; rosaramicin; rosaramicin butyrate; rosaramicin propionate; rosaramicin sodium phosphate; rosaramicin stearate; rosoxacin; roxarsone; roxithromycin; sancycline; sanfetrinem sodium; sarmoxicillin; sarpicillin; scopafungin; sisomicin; sisomicin sulfate, sparfloxacin; spectinomycin hydrochloride; spiramycin; stallimycin hydrochloride; steffimycin; streptomycin sulfate; streptonicozid; sulfabenz; sulfabenzamide; sulfacetamide; sulfacetamide sodium; sulfacytine; sulfadiazine; sulfadiazine sodium; sulfadoxine; sulfalene; sulfamerazine; sulfameter; sulfamethazine; sulfamethizole; sulfamethoxazole; sulfamonomethoxine; sulfamoxole; sulfanilate zinc; sulfanitran; sulfasalazine; sulfasomizole; sulfathiazole; sulfazamet; sulfisoxazole; sulfisoxazole acetyl; sulfisboxazole diolamine; sulfomyxin; sulopenem; sultamricillin; suncillin sodium; talampicillin hydrochloride; teicoplanin; temafloxacin hydrochloride; temocillin; tetracycline; tetracycline hydrochloride; tetracycline phosphate complex; tetroxoprim; thiamphenicol; thiphencillin potassium; ticarcillin cresyl sodium; ticarcillin disodium; ticarcillin monosodium; ticlatone; tiodonium chloride; tobramycin; tobramycin sulfate; tosufloxacin; trimethoprim; trimethoprim sulfate; trisulfapyrimidines; troleandomycin; trospectomycin sulfate; tyrothricin; vancomycin; vancomycin hydrochloride; virginiamycin; zorbamycin; bifonazolem; butoconazole; clotrimazole; econazole; fenticonazole; isoconazole; ketoconazole; miconazolel omoconazolel oxiconazolel sertaconazolel sulconazolel tioconazolel; albaconazole; fluconazole; isavuconazole; itraconazole; posaconazole; ravuconazole; terconazole; voriconazole; abafungin; amorolfin; butenafine; naftifine; terbinafine; anidulafungin; caspofungin; micafungin; and combinations thereof.

In particular examples, antimicrobial agents suitable for the methods, compositions and uses of the present disclosure as they relate to biofilms comprising methicillin-sensitive Staphylococcus include, but are not limited to, methicillin, nafcillin, oxacillin, cloxacillin, dicloxacillin, and flucloxacillin. Antimicrobials suitable for use in combination with auranofin in the methods related to biofilms comprising MRSA infection include, but are not limited to, clindamycin, co-trimoxazole, rifampicin, lincomycin, vancomycin, teicoplanin and mupirocin, and combinations thereof.

In other examples, antimicrobial agents suitable for the methods, compositions and uses of the present disclosure as they relate to biofilms comprising K. pneumoniae, include, but are not limited to, ampicillin, piperacillin, tazobactam, amoxicillin, carbenicillin, ticarcillin, gentamicin, ceftazidime, cefepime, levofloxacin, ciprofloxacin, gemifloxacin, norfloxacin, gaitfloxacin, moxifloxacin, amikacin, tobramycin, clavulanate, aztreonam, meropenem, and ertapenem, and combinations thereof.

In further examples, antimicrobial agents suitable for the methods, compositions and uses of the present disclosure as they relate to biofilms comprising A. baumannii, include, but are not limited to, imipenem, meropenem, cefepime, ciprofloxacin, colistimethate, ampicillin/sulbactam, colistin, minocycline, piperacillin, tazobactam, tigecycline, polymyxin B, polymyxin E, and amikacin, and combinations thereof.

In further examples, antimicrobial agents suitable for the methods, compositions and uses of the present disclosure as they relate to biofilms comprising yeast and filamentous fungi include antifungals, including, but not limited to, imidazoles (e.g. bifonazolem butoconazole, clotrimazole, econazole, fenticonazole, isoconazole, ketoconazole, miconazole, omoconazole, oxiconazole, sertaconazole, sulconazole, tioconazole, triazoles (e.g. albaconazole, fluconazole, isavuconazole, itraconazole, posaconazole, ravuconazole, terconazole, voriconazole), thiazoles (e.g. abafungin), allylamines (e.g. amorolfin, butenafine, naftifine, terbinafine) and echinocandins (anidulafungin, caspofungin, micafungin).

The auranofin can be formulated as a composition in a manner suitable for the desired application. Accordingly, provided are compositions comprising auranofin for use in the methods of the present disclosure. The auranofin can be produced by any method known in the art. For example, auranofin can be produced by methods such as those described in U.S. Pat. Nos. 4,115,642, 4,122,254, 4,125,710, 4,125,711, 4,131,732, 4,133,952 and 4,200,738.

The particular formulation of the composition comprising auranofin will depend on the application or delivery method to the required surface and thus will vary with different applications. For example a composition containing auranofin may be formulated for in vivo administration, such as in the form of a liquid, suspension, syrup, nasal spray (including in a form for administration using a nebulizer), eyedrops, powder, tablet, capsule, cream, paste, gel or lotion. In some examples, the compositions form components of, for example, surgical dressings, mouthwash or toothpaste. In further examples, auranofin is formulated for controlled release. For industrial and domestic applications, such as coating or impregnation of a surface of an object, the composition may be formulated as a paint, wax, other coating, emulsion, solution, gel, suspension, beads, powder, granules, pellets, flakes or spray. The skilled addressee will recognise that the appropriate formulation will depend on the particular application and the proposed route of delivery.

For in vivo administration to a subject, compositions containing auranofin may include one or more pharmaceutically acceptable carriers, excipients or diluents. Examples of pharmaceutically acceptable carriers, excipients or diluents are demineralised or distilled water; saline solution; vegetable based oils such as peanut oil, safflower oil, olive oil, cottonseed oil, maize oil, sesame oil, arachis oil or coconut oil; silicone oils, including polysiloxanes, such as methyl polysiloxane, phenyl polysiloxane and methylphenyl polysolpoxane; volatile silicones; mineral oils such as liquid paraffin, soft paraffin or squalane; cellulose; cellulose derivatives such as methyl cellulose, ethyl cellulose, carboxymethylcellulose, sodium carboxymethylcellulose or hydroxypropylmethylcellulose; lower alkanols, for example ethanol or iso-propanol; lower aralkanols; lower polyalkylene glycols or lower alkylene glycols, for example polyethylene glycol, polypropylene glycol, ethylene glycol, propylene glycol, 1,3-butylene glycol or glycerin; fatty acid esters such as isopropyl palmitate, isopropyl myristate or ethyl oleate; polyvinylpyrridone; agar; carrageenan; gum tragacanth or gum acacia, and petroleum jelly.

The compositions comprising auranofin are formulated with an amount or concentration of auranofin that is suitable for use in the particular embodiment of the disclosure, e.g. at concentrations or amounts sufficient to inhibit the formation of a biofilm; reduce the biomass of a biofilm; promote dispersal of microorganisms within a biofilm; sensitize a biofilm or microorganisms within the biofilm to an antimicrobial agent; inhibit the growth of microorganisms; or treat or prevent an infection, disease or condition caused by or associated with a microorganism or biofilm described herein. The compositions can be formulated for direct administration to a surface, or can be formulated as a concentrated composition that is subsequently diluted prior to use. In some instances, the compositions are in solid form, such as in tablet or capsule form, and contain auranofin at a concentration of between about 0.01% (w/w) and about 50% (w/w), between about 0.1% (w/w) and about 20% (w/w), between about 0.5% (w/w) and about 10% (w/w), or between about 1% (w/w) and about 5% (w/w). In other instances, the compositions are in liquid form. In particular embodiments, such compositions are formulated with between about 1 ng/mL and about 100 mg/mL, between about 10 ng/mL and about 100 mg/mL, between about 100 ng/mL and about 1 100 mg/mL, between about 1 μg/mL and about 10 mg/mL, between about 10 μg/mL and about 10 mg/mL, between about 100 μg/mL and about 10 mg/mL, or between about 1 mg/mL and about 10 mg/mL compound. The most suitable concentration to achieve the desired effect will depend on a number of factors and may be determined by those skilled in the art using routine experimentation.

In particular embodiments of the present disclosure, the auranofin is formulated as a pharmaceutical composition for administration to subject, such as to treat an infectious disease or condition associated with a microorganism described herein. The compositions can be administered to a subject in therapeutically effective amounts (e.g., amounts that prevent or reduce progression of a disease or condition) to provide therapy for the disease or condition. The precise amount or dose of the auranofin that is administered to the subject depends on several factors, including, but not limited to, the severity of the disease or condition, the use of other antimicrobial agents, the route of administration, the number of dosages administered, and other considerations, such as the weight, age and general state of the subject. Particular dosages can be empirically determined or extrapolated from, for example, studies in animal models or previous studies in humans. For example, in some embodiments, the auranofin is administrated to a subject at a dose of between about 0.05 mg auranofin/kg body weight and about 100 mg/kg, such as at least or about 0.05 mg/kg, 0.1 mg/kg, 0.5 mg/kg, 1 mg/kg, 1.5 mg/kg, 2 mg/kg, 2.5 mg/kg, 3 mg/kg, 3.5 mg/kg, 4 mg/kg, 4.5 mg/kg, 5 mg/kg, 5.5 mg/kg, 6 mg/kg, 6.5 mg/kg, 7 mg/kg, 7.5 mg/kg, 8 mg/kg, 8.5 mg/kg, 9 mg/kg, 9.5 mg/kg, 10 mg/kg, 11 mg/kg, 12 mg/kg, 13 mg/kg, 14 mg/kg, 15 mg/kg, 20 mg/kg, 25 mg/kg, 30 mg/kg, 35 mg/kg, 40 mg/kg, 45 mg/kg, 50 mg/kg, 60 mg/kg, 70 mg/kg, 80 mg/kg, 90 mg/kg, 100 mg/kg, or more. It is well within the skill of a skilled artisan to determine the appropriate dose to administer to a subject.

The effectiveness of the provided methods can be monitored or assessed by any method known in the art. For example, biofilm-forming assays and microbial growth assays such as those described in the Examples below can be used to determine the effect of exposing a biofilm or microorganism to auranofin. In examples where a subject is being treated by administration of auranofin, biological samples (e.g. blood, plasma, serum, sputum, saliva, urine, stool, vaginal secretions, bile, lymph, and cerebrospinal fluids, and swabs of a body surface such as skin or mucosa) can be obtained before, during and/or after administration of the compound and the presence of microorganisms in the sample can be assessed using a bacterial growth assay to determine the effect of treatment. In other examples, the presence of microorganisms in a sample taken before, during and/or after administration of the compound to a subject can be assessed using immunoassays that detect one or more microbial antigens, and such assays are well known in the art. In some embodiments, the monitoring or assessment of the methods of the present disclosure can be used to alter one or more parameters, such as duration of treatment, dose, or route of administration.

Those skilled in the art will appreciate that the aspects and embodiments described herein are susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations of any two or more of said steps or features.

The citation of any reference herein should not be construed as an admission that such reference is available as “Prior Art” to the present application. Further, the reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The present disclosure is further described by reference to the following non-limiting examples.

### EXAMPLES

### Example 1. Effect of Auranofin on the Growth of S. aureus

### Growth Assay

A growth assay was used to determine whether auranofin could inhibit the growth of S. aureus NCTC 8325, S. aureus clinical isolates 04-229-2455, 04-228-1825, 04-227-3567 and 02-228-3611, and hospital and community acquired MRSA strains IMVS67 (nmMRSA D), RBH98 (QLD), PAH58 (SWP), MW2 (USA400), CH16 (UK EMRSA-15) RPAH18 (Aus-2) and USA300.

Auranofin (Sigma Aldrich) was formulated as a stock concentration at 2 mg/mL in DMSO, before being further serially diluted in DMSO. S. aureus strains were grown overnight in Cation-Adjusted Mueller-Hinton Broth (CaMHB) and diluted to approximately 5×10⁷ cfu/mL (i.e. 1/100) before 150 μL was added to each well of a flat bottomed 96-well plate. Three microliters of the diluted auranofin was added to the wells in duplicate. Controls included a serial dilution of lincomycin in ethanol (to assess plate to plate variation), a positive control with bacteria alone in CaMHB with 2% DMSO, and a negative (no bacteria) control with 150 μL CaMHB containing 2% DMSO. Plates were incubated in a shaking incubator at 37° C. for 22-24 hours and absorbance was measured at a wavelength of 595 nm using a Synergy HT Bio-Tek plate reader. The growth of S. aureus was then assessed as a percentage of the positive control (bacteria alone) and the IC₅₀ values determined.

Variation of growth assays for:
M. abscessus: use of 1/100 overnight dilution to set up assay, medium used: Todd Hewitt broth supplemented with 0.5%/0 yeast extract and 1% glucose. Assay was incubated for 4-5 days.
Group A Streptococcus (#2): use of 1/100 overnight dilution to set up assay, medium used: Todd Hewitt broth supplemented with 0.5% yeast extract. Assay was incubated for 22-24 h.
P. vulgaris: use of 1/100 overnight dilution to set up assay, medium used: Luria Bertani (LB) broth. Assay was incubated for 22-24 h.

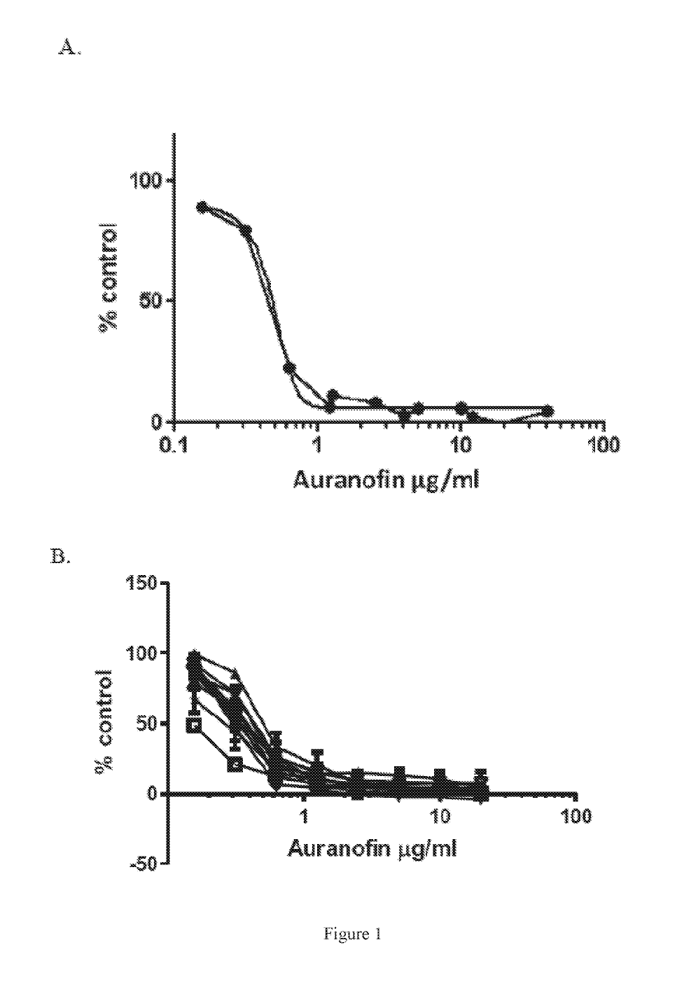

Auranofin efficiently inhibited growth of the laboratory strain of S. aureus (S. aureus NCTC 8325), exhibiting an IC₅₀ of 0.5 μg/mL or 740 nM (FIG. 1A). This inhibitory effect of auranofin was also observed on S. aureus clinical isolates, with a similar IC₅₀ of 0.4-0.5 μg/mL (FIG. 1B).

### Time-Kill Assay

The effect of auranofin on the growth of S. aureus was also assessed using a time kill assay. Exponentially growing S. aureus NCTC 8325 were diluted to approximately 5×10⁶ cfu/mL in tryptic soy broth (TSB) and auranofin, rifampicin or both auranofin and rifampicin were added. Auranofin was added to cultures at a concentration of 5 μg/mL; 1 μg/mL or 0.5 μg/mL. Rifampicin was added to cultures at a concentration of 1 μg/mL or 0.2 pig/mL, while cultures with auranofin and rifampicin had 0.5 μg/mL auranofin and 0.2 μg/mL rifampicin. Cultures were sampled at various time points and colony forming units determined.

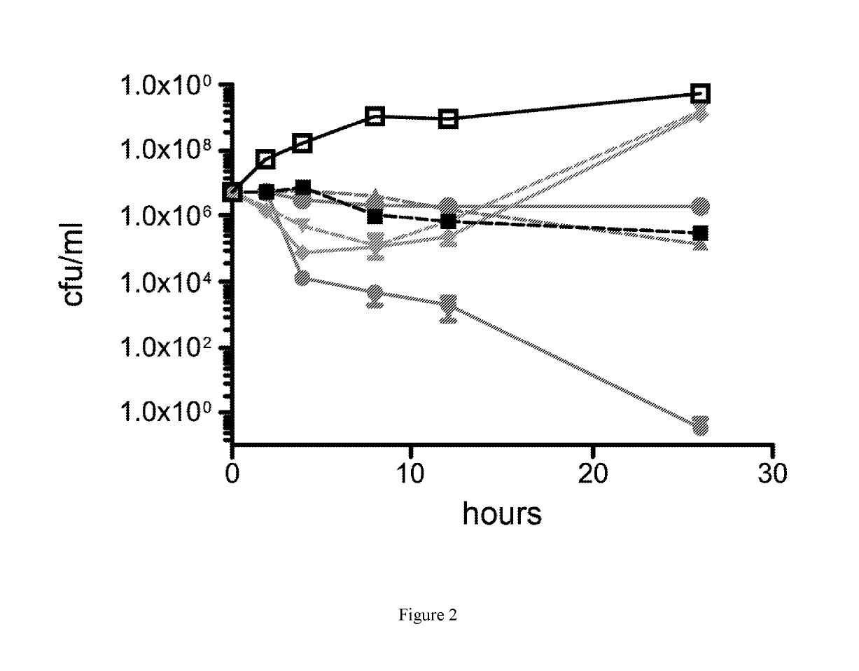

It was observed that the growth inhibitory effect of auranofin was both concentration- and time-dependent (FIG. 2).

### THP-1 Cells

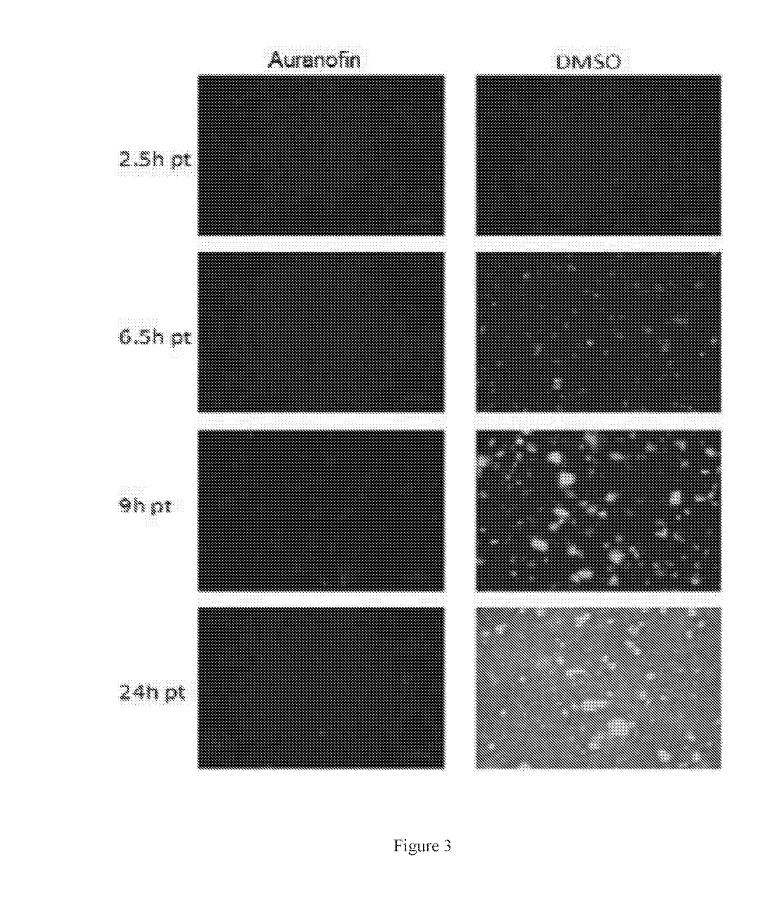

THP-1, a human monocytic cell line was infected with S. aureus (strain SH1000-GFP) at a multiplicity of infection of 3 for 1.5. hours. Cells were washed 3 times and auranofin (1 μg/ml in 0.5% DMSO) or 0.5% DMSO was added. Cells were observed under a fluorescent microscope at various time points post infection (FIG. 3). Auranofin inhibited intracellular and extracellular S. aureus growth over a period of 24 h. Infected cells treated with DMSO showed accumulation of intracellular and extracellular bacteria and cell death occurred around 7 h (as judged by cell morphology).

### Example 2. Effect of Auranofin on S. aureus Biofilm Formation

The effect of auranofin on the formation of S. aureus biofilms was assessed using a biofilm prevention assay as described by Merritt et al. Current Protocols in Microbiology, 2011, 1B.1.1-1B1.18 with slight modifications. Briefly, S. aureus NCTC 8325, MRSA (RPAH18) and MRSA (MW2) were grown overnight in Tryptic soy broth (TSB) and diluted to between 1/50 and 1/100 before 150 μL was added to the wells of a flat bottomed 96-well plate. Three microliters of auranofin at the appropriate dilution in DMSO was added to the wells in duplicate. Controls included a serial dilution of lincomycin in ethanol (to assess plate to plate variation), a positive control with bacteria alone in TSB with 2% DMSO and a negative (no bacteria) control with 150 μL TSB containing 2% DMSO. Plates were sealed with AeraSeal™ and incubated at 37° C. for 24 hours. The plates were then washed three times with PBS, dried at 60° C. for 1 hour and stained with crystal violet for 1 hour. The plates were again washed three times with water, dried and scanned prior to the addition of 33% acetic acid to re-solubilize the crystal violet stain bound to the adherent cells. Absorbance was then measured at 630 nm and expressed as a percentage of the bacteria only control.

Under these assay conditions auranofin completely prevented biofilm formation by both S. aureus NCTC 8325 and MRSA (RPAH18) at a concentration of approximately 1 μg/mL (FIGS. 4A and 4B, respectively). Similar prevention of auranofin biofilm formation by MRSA (MW2) was observed (data not shown).

Auranofin (0.3 μg/mL-20 pig/mL) was also observed to inhibit biofilm formation by S. aureus NCTC 8325 when used in combination with, independently, the antibiotics erythromycin, lincomycin, gentamicin and vancomycin. The fractional inhibitory concentration index (FICI) was calculated using the following formula: (MIC [auranofin tested in combination]/MIC [auranofin tested in combination])+(MIC [antibiotic tested in combination]/MIC [antibiotic alone]). Table 1 shows the FICI as determined with data from 5 separate assays. A FICI of <0.5 suggests synergy, a FICI of >4 is defined as antagonism, a FICI of >0.5-1 is indicative of an additive effect and a FICI between 1 and 4 is considered indifferent (NE=no effect, i.e. the MICs in combination were similar to MIC alone; ND=not done).

TABLE 1

| | Fractional Inhibitory Concentration Index | | | | | |
|---|---|---|---|---|---|---|
| Auranofin/ | 0.55 | 0.5 | NE | 0.8 | 0.35 | NE |
| Erythromycin | | | | | | |
| Auranofin/Penicillin G | NE | NE | ND | ND | ND | ND |
| Auranofin/ | ND | 0.5 | NE | 0.8 | 0.8 | NE |
| Lincomycin | | | | | | |
| Auranofin/ | 0.7 | 0.4 | 0.8 | 0.6 | 0.8 | 0.35 |
| Gentamicin | | | | | | |
| Auranofin/ | 0.63 | NE | NE | ND | ND | ND |
| vancomycin | | | | | | |

### Example 3. Effect of Auranofin on Preformed S. aureus Biofilms

The effect of auranofin, alone and in combination with antibiotics, on preformed S. aureus biofilms was assessed. Briefly S. aureus NCTC 8325 was plated in 96-well plates as described in Example 2 and incubated 37° C. for 24 hours. Biofilms were then washed 3 times with TSB and 150 μL of fresh TSB and 3 μL of auranofin at the appropriate dilution in DMSO was added to the wells in duplicate. Plates were again sealed with AeraSeal™ and reincubated 37° C. for 24 hours. Biofilm was then detected as described in above.

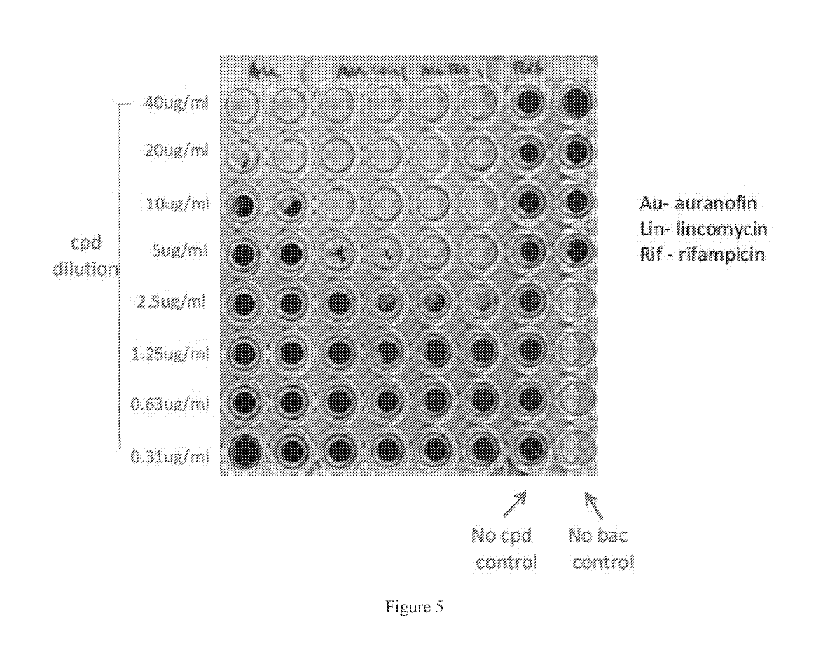

Auranofin exhibited a dose-dependent inhibitory effect on existing S. aureus biofilms, as determined by crystal violet staining. As shown in FIG. 5, treatment with concentrations of 20 μg/mL and 40 μg/mL auranofin dispersed the bacteria within the biofilm, essentially eliminating the biofilm. Conversely, even high concentrations of rifampicin did not treat preformed biofilm. Exposing the biofilm to a combination of auranofin and rifampicin or auranofin and lincomycin significantly enhanced the effect of these compounds.

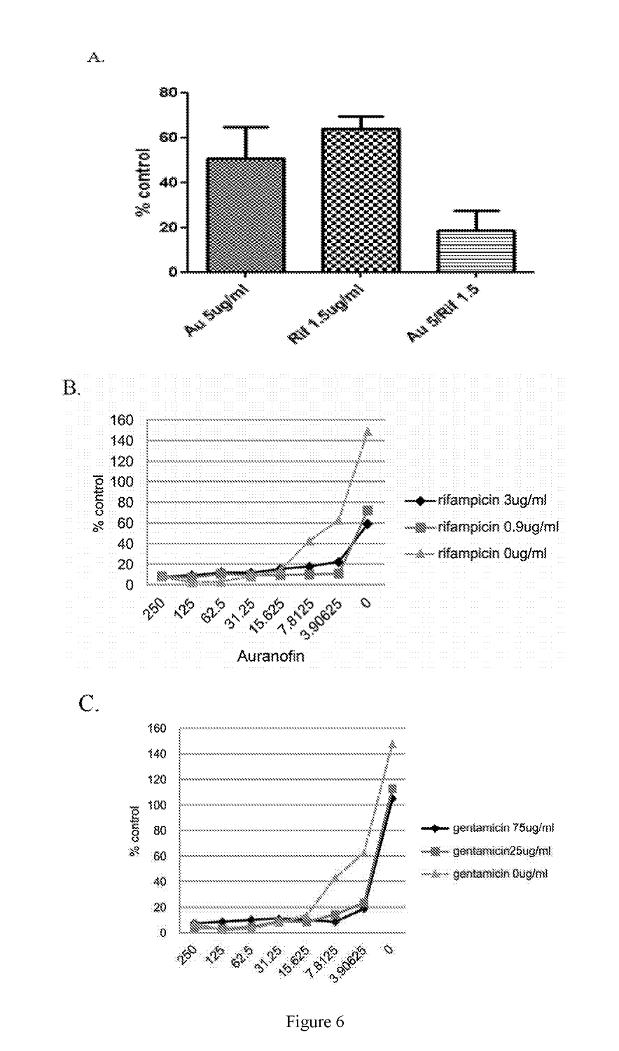

The enhanced treatment effect of a combination of auranofin and rifampicin was further demonstrated with an assay utilising 5 μg/mL auranofin and 1.5 μg/mL rifampicin (FIG. 6A) alone and in combination. While either of these compounds alone had only a partial effect on the biofilm, a combination of the two reduced the biomass of the biofilm to approximately 20% of the negative control. FIGS. 6B and 6C show the inhibitory effect of varying concentrations of auranofin in combination with 0.9 or 3 μg/mL rifampicin (FIG. 6B) or with 25 or 75 μg/mL gentamicin (FIG. 6C). Whereas, both rifampicin and gentamicin at both concentrations had no effect on biofilm mass, in each case the addition of as little as 3.90 μg/mL auranofin resulted in significant reductions in biofilm mass.

### Example 4. Inability of S. aureus to Develop Resistance to Auranofin

To determine the frequency at which S. aureus generates resistance to auranofin, three separate assays were performed: a disc-diffusion assay, a resistance-frequency assay and a time-kill assay.

### Disc Assay

Bacteria were plated on TSB agar. 3M discs (impregnated with 4 μg auranofin, 4 μg rifampicin or DMSO alone) were placed on top of the agar. The plates were incubated overnight at 37° C. and any zone of bacterial inhibition was measured. Any bacterial colonies growing within this zone of inhibition were picked and subsequently analysed for potential resistance against the appropriate compound/antibiotic using a growth or biofilm formation assay as described above. No growth was observed the auranofin zone of inhibition, however mutants were isolated from the rifampicin (Rif) zone of inhibition. These S. aureus Rif mutants were tested in a growth assay and their rifampicin resistance confirmed.

It was observed that while both auranofin and rifampicin produced zones of inhibition around S. aureus NCTC 8325 and the various clinical isolates (including MRSA strains IMVS67 (nmMRSA D), RBH98 (QLD), PAH58 (SWP), MW2 (USA400), CH16 (UK EMRSA-15) RPAH18 (Aus-2) and USA300) resistant bacterial colonies were only present in the rifampicin zone of inhibition (data not shown). Thus, neither S. aureus NCTC 8325 nor any of the clinical isolates were observed to develop resistance to auranofin. Conversely, colonies of nearly all isolates were observed in the rifampicin zones of inhibition in accordance with previously published data suggesting that the mutation frequency of rifampicin is approximately 10⁻⁸ (O'Neill et al. J. Antimicrob. Chemother. (2001) 47 (5): 647-650.)

### Resistance Frequency Assay

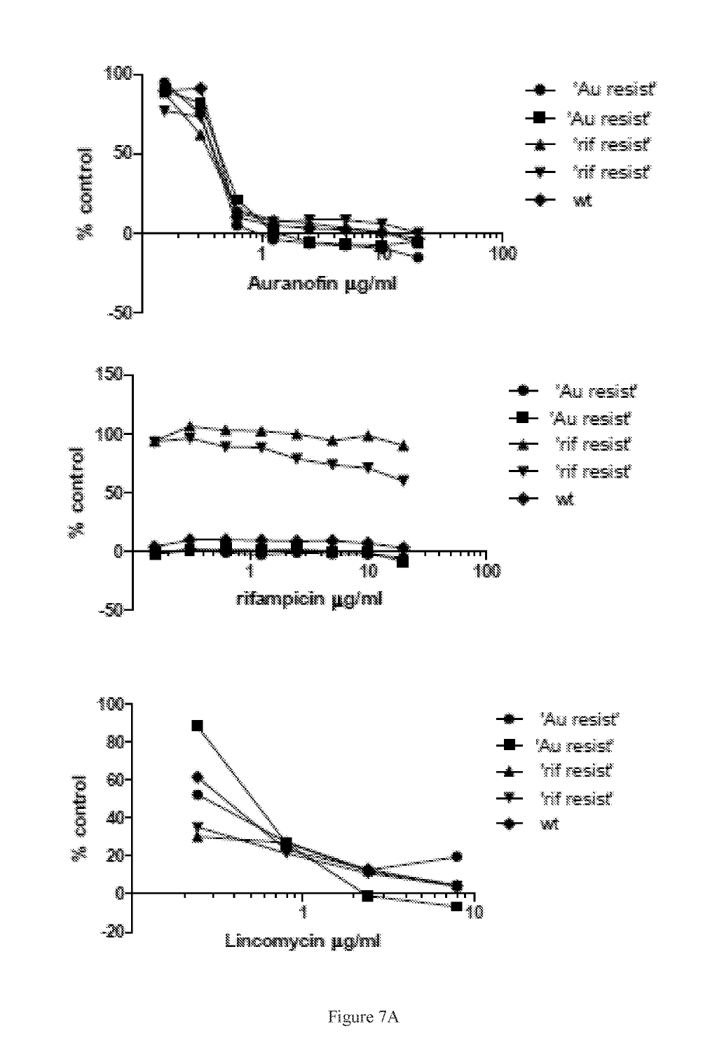

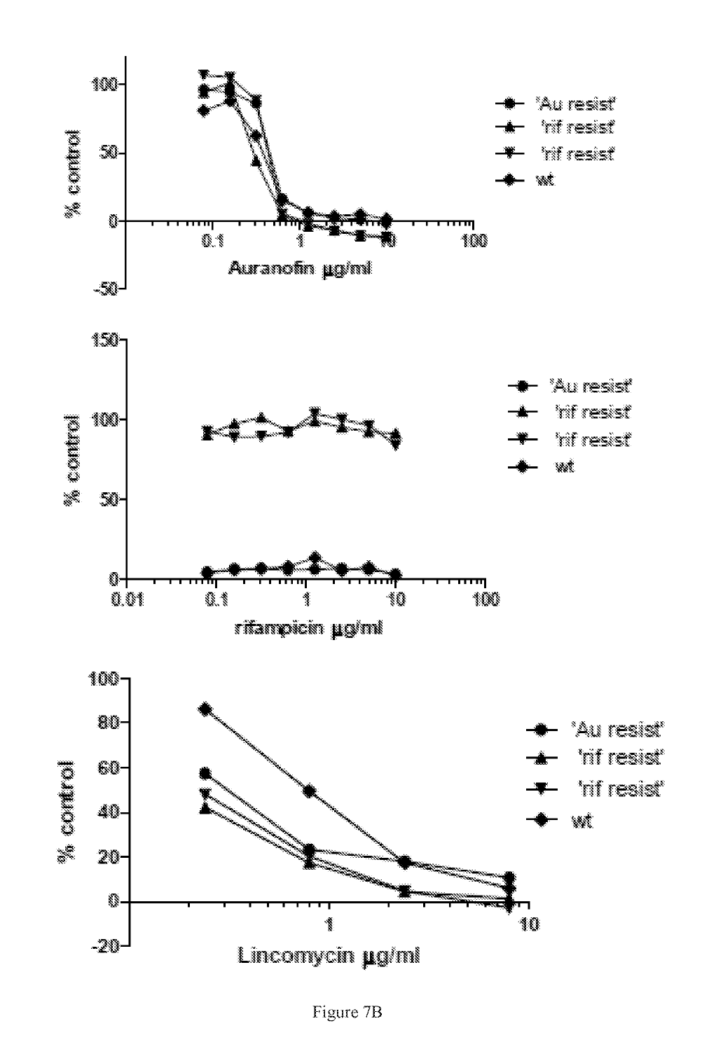

Two resistance frequency assays were set up according to Stokes et al. (J Biol Chem (2005) 280: 39709-39715). Briefly, S. aureus was streaked out on TSB agar plates containing 1×, 1.5×, 2× and 4× the minimum inhibitory concentration of auranofin (1 μg/mL). Any potential mutants were picked and assessed for resistance. The potentially resistant bacteria were cultured overnight in CaMHB broth containing serial dilutions of auranofin, rifampicin or lincomycin and assessed for their resistance profile by measuring the growth of the bacteria in a growth assay and comparing it to the control. “Wild-type” bacteria that had not originally been grown in the agar plates and which were not resistant were also included in the growth assay. “Rif resistant cells” were picked from the rifampicin zone of inhibition and potential “Au resistant” mutants were picked from the edge of the auranofin zone of inhibition and tested. It was observed that none of the potentially auranofin-resistant bacteria picked from agar plates were actually resistant, as no growth was observed in broth containing auranofin (FIGS. 7A & B). Conversely, the potentially rifampicin-resistant bacteria picked from agar plates were fully resistant, as these bacterial cultures grew to the same level as the controls. The wild-type (i.e. sensitive) bacteria showed no growth.

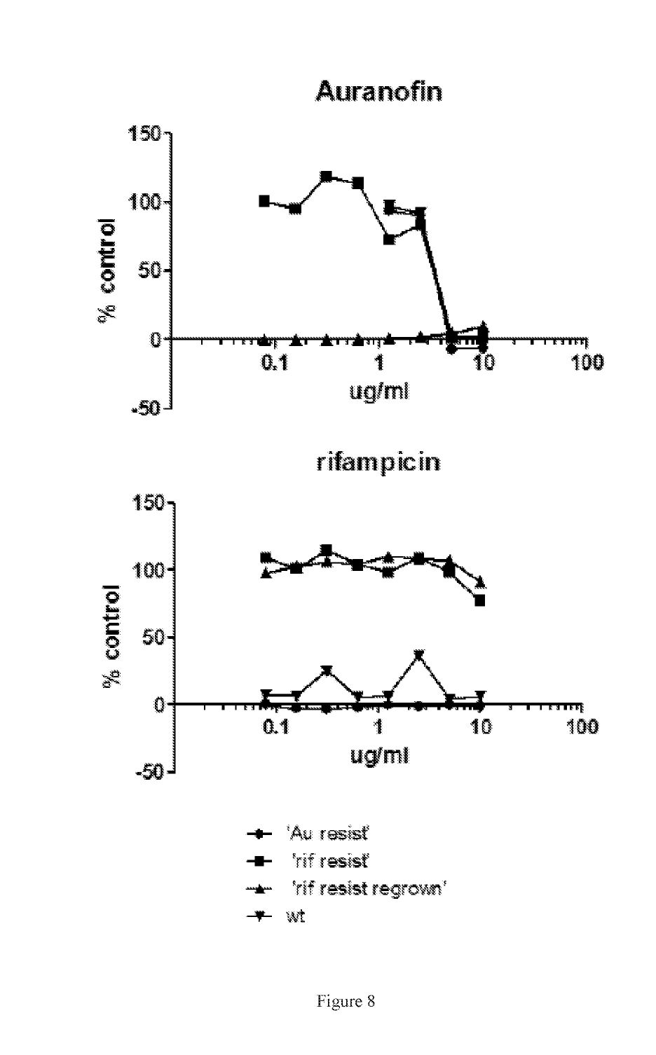

The potential mutants were also analysed using the biofilm prevention assay described in Example 2, above. In this assay, S. aureus cultured to biofilm formation in the absence of auranofin or rifampicin was used as the control, and absorbance following crystal violet staining of the potentially resistant bacteria was expressed as a percentage of the control. As demonstrated in FIG. 8, none of the potentially auranofin-resistant bacteria were able to form biofilms in the presence of greater than about 3 μg/mL auranofin. Conversely, the potentially rifampicin-resistant bacteria were shown to be resistant to all concentrations of rifampicin, forming biofilms in the same manner as bacteria cultured in the absence of the compound.

### Time-Kill Assay

The time kill assay described above in Example 1 was observed to assess the development of auranofin- or rifampicin-resistant bacteria over time. As can be seen in FIG. 2, no resistant bacteria were observed in the presence of 0.5 μg/mL, 1 μg/mL, or 5 μg/mL auranofin, or in the presence of a combination of 0.5 μg/mL auranofin and 0.2 μg/mL rifampicin, as indicated by the lack of bacterial growth over time. By comparison, in the presence of 0.2 μg/mL and 1 μg/mL rifampicin, bacterial growth starts to increase after about 10 hours, indicating the development of rifampicin resistance.

### Susceptibility of Rifampicin-Resistant Mutants to Auranofin

The susceptibility of the rifampicin-resistant mutants to auranofin was assessed using the disc assay method. Briefly, cultures containing the confirmed rifampicin-resistant mutants were heavily streaked out on TSB agar before discs impregnated with 4 μg auranofin, 4 μg rifampicin, auranofin/rifampicin (4 μg each) or DMSO alone were placed on top of the agar. The plates were incubated overnight at 37° C. and any zone of bacterial inhibition was noted. Zones of inhibition formed around discs containing auranofin or auranofin/rifampicin but not around discs containing rifampicin or DMSO, indicating that the rifampicin-resistant mutants remained susceptible to auranofin and resistant to rifampicin (data not shown).

### Conclusion

None of the S. aureus strains (either the laboratory strain or the clinical isolates) developed resistance to auranofin. Conversely, mutants with resistance to rifampicin routinely developed. Further, rifampicin-resistant mutants remained susceptible to auranofin.

### Example 5. Effect of Auranofin on Multi-Drug Resistant Klebsiella pneumoniae

The ability of auranofin to inhibit the growth of four multi-drug resistant clinical isolates of K. pneumoniae was assessed. The clinical isolates were C204742 (resistant to ampicillin and gentamicin), C68761 (resistant to ampicillin, trimethoprim and sulfamethoxazole), C188681 (resistant to ampicillin, trimethoprim, sulfamethoxazole, ceftazidime, tobramycin and ciprofloxacin) and C71173 (resistant to ampicillin, trimethoprim, sulfamethoxazole, ceftazidime, tobramycin, gentamicin and ciprofloxacin). These strains have been previously described in Chowdhury et al., (2011) Antimicrob Agents Chemother 55: 3140-3149.

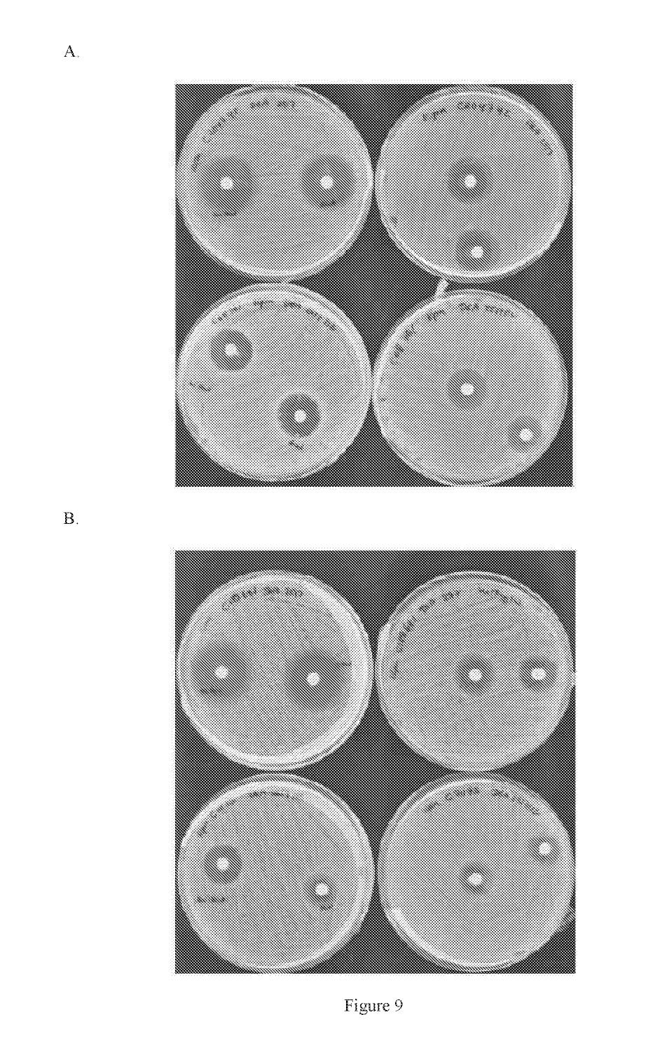

Bacterial colonies were picked and diluted 1/1000 in Luria broth (LB). 100 μL of each dilution was then streaked out on LB plates. Discs impregnated with 100 μg auranofin or 100 μg gentimicin or auranofin and gentamicin (100 μg each) were placed on top of the agar. The plates were incubated overnight at 37° C. and any zone of bacterial inhibition was noted. As shown in FIG. 9, auranofin shows inhibitory activity against all four multi-drug resistant clinical isolates tested. In some cases, such as with strain C71173, auranofin in combination with gentamicin appeared to enhance killing.

### Example 6. Effect of Auranofin on Acinetobacter baumannii

The ability of auranofin to inhibit the growth of A. baumannii was assessed by growth assays and disc assay.

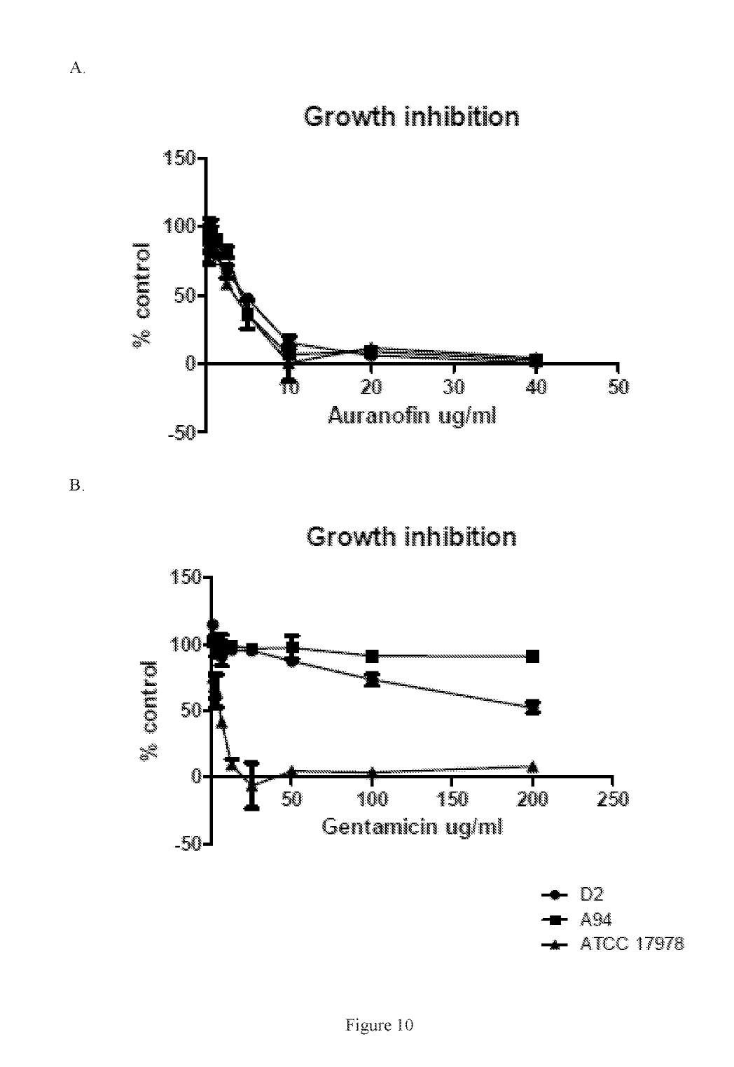

In the first growth assay, three strains of A. baumannii (D2, A94 and ATCC 17978) were cultured in LB in the presence of 1.25, 2.5, 5, 10, 20 or 40 μg/mL auranofin or 1.56, 3.13, 6.25, 12.5, 25, 50, 100 or 200 μg/mL gentamicin for 22-24 hours. Bacterial strains were also grown in the absence of antibiotic, and these were used as controls. The bacterial growth was determined by the measurement of absorbance at 595 nm using a Synergy HT Bio-Tek plate reader. The growth of A. baumannii was then assessed as a percentage of the positive control (bacteria alone grown in the presence of 2% DMSO). As demonstrated in FIG. 10A, all three strains were susceptible to auranofin, (MIC of approximately 10 μg/mL). Conversely, A. baumannii D2 was completely resistant and A94 was partially resistant to gentamicin, and only A. baumannii ATCC 17978 was susceptible (FIG. 10B).

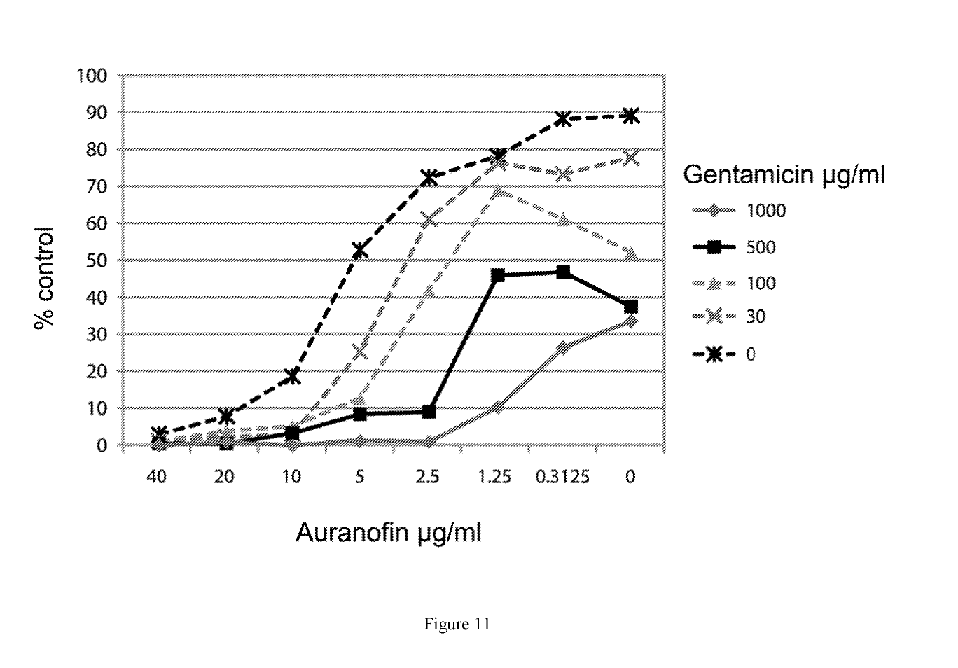

A second growth assay was then performed to determine the effect of a combination of auranofin and gentamicin on bacterial growth. Briefly, A. baumannii was cultured in LB medium for 22-24 hours in the presence of 0, 0.3125, 0.125, 2.5, 5, 10, 20 or 40 μg/ml auranofin and 0, 30, 100, 300 or 1000 μg/ml gentamicin before growth was determined by the measurement of absorbance at 595 nm using a Synergy HT Bio-Tek plate reader. The growth of A. baumannii was then assessed as a percentage of the positive control (bacteria alone grown in the presence of 2% DMSO). Enhanced inhibition of A. baumannii growth was observed when a combination of auranofin and gentamicin was used (FIG. 11).

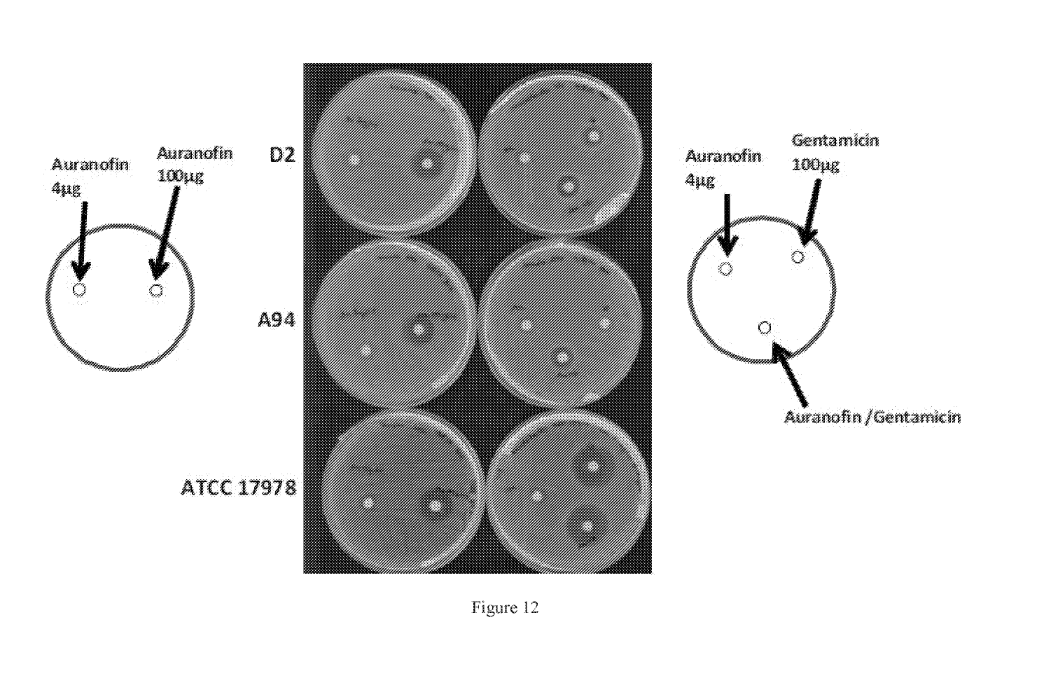

These results were confirmed using a disc diffusion assay, which was performed essentially as described above. Briefly, A. baumannii D2, A94 and ATCC 17978 were plated on LB agar plates onto which discs impregnated with 4 μg or 100 μg auranofin, 100 μg gentamicin or 4 μg auranofin and 100 μg gentamicin (FIG. 12).

### Example 7. Effect of Auranofin on A. baumannii Biofilm Formation

The effect of auranofin on the formation of A. baumannii D2 biofilm formation was assessed using the biofilm prevention assay described above in Example 2 with slight modifications. Briefly, A. baumannii D2 were grown overnight in LB media and diluted 1/100 before 150 μL was added to the wells of a flat bottomed 96-well plate. Three microliters of auranofin or gentamicin at the appropriate dilution in DMSO was added to the wells in duplicate. Controls included a positive control with bacteria alone with media and 2% DMSO and a negative (no bacteria) control with media containing 2% DMSO. Plates were sealed with AeraSeal™ and incubated at 37° C. for 24 hours. The plates were then washed three times with PBS, dried at 60° C. for 1 hour and stained with crystal violet for 1 hour. The plates were again washed three times with water, dried and scanned prior to the addition of 33% acetic acid to re-solubilize the crystal violet stain bound to the adherent cells. Absorbance was then measured at 595 nm and expressed as a percentage of the bacteria only control.

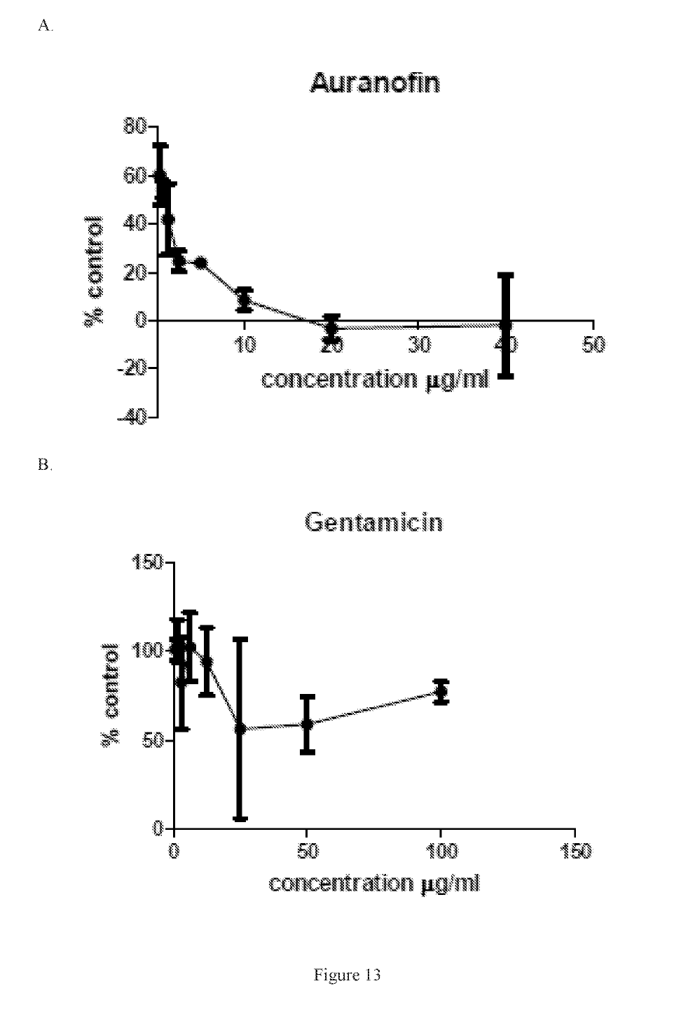

Under these assay conditions, auranofin completely prevented biofilm formation by A. baumannii D2 at a concentration of approximately 20 μg/mL (FIG. 13A). Conversely, gentamicin was unable to prevent formation of biofilms by A. baumannii D2, even at a concentration of 20 μg/mL (FIG. 13B).

### Example 8. Effect of Auranofin on Growth of Other Bacterial Species

Growth assays were carried out as described in Example 1 to determine the ability of auranofin to inhibit the growth of a range of Gram positive and Gram negative bacterial species. The results are shown in Table 2.

TABLE 2

| Bacteria | MIC (μg/ml) |
|---|---|
| Gram positive | |
| Enterococcus faecalis (ATCC 29212) | ~1.3 |
| Streptococcus pneumoniae (ATCC 49619 and D39¹) | ~0.3 |
| Group A Streptococcus (clinical isolate 30069) | ~0.2 |
| Group A Streptococcus (#2) | <1 |
| Mycobacterium abscessus | 1.9-3.9 |
| Gram negative | |
| Salmonella typhimurium (clinical isolates) | 15-500 |
| Salmonella typhimurium (ATCC 14028) | 62 |
| Vibrio cholerae (including multi-drug | 2-5 |
| resistant clinical isolates) | |
| Shewanella spp. | 8 (80% inhibition) |
| Proteus vulgaris | 50 |

### Example 9. Activity of Auranofin is Linked with Impaired Redox-Pathway Activity and Enhanced Oxidative Stress

Auranofin has been suggested to inhibit thioredoxin reductase in mammalian cells and recently in bacteria (Harbut et al. (2015), PNAS, 112:14; 4453-4458). The thioredoxin (Trx) pathway protects bacterial cells from oxidative stress and this pathway is essential in many (but not all) Gram-positive bacteria and some Gram-negative bacteria.

Most Gram negative bacteria possess a second pathway to deal with oxidative stress, the glutathione (GSH) and glutathione reductase pathway (GR). GR is encoded by the gor gene. GshA encodes a γ-Glutamate-cysteine ligase which catalyses the first of two steps in the pathway for the biosynthesis of GSH. GshB, a glutathione synthetase catalyses the final step in the pathway for the biosynthesis of glutathione.

To determine whether auranofin acts on the antioxidant pathway mutants from the Keio library, containing single-knockout mutants for all non-essential genes of E. coli K12 were tested in a growth assay.

Auranofin stock solution (20 mg/ml) in dimethyl sulfoxide (DMSO) was serially diluted in DMSO and each dilution added in duplicate to a 96-well plate to a final DMSO concentration of 2% (v/v). An overnight culture of E. coli mutants and wild type were diluted 1:100 in Luria Bertani (LB) broth and 150 μl of this sample was added to each well of the 96-well plates. Control wells included an ‘untreated’ control with bacteria in the presence of 2% DMSO and a negative sample (containing 1501 growth media in the presence of 2% DMSO). Plates were incubated at 370 C for 22-24 h and bacterial growth assessed by absorbance at a wavelength of 595 nm. The minimum inhibitory concentration (MIC) was defined as the lowest concentration of compound that inhibited growth compared to the no-treatment control.

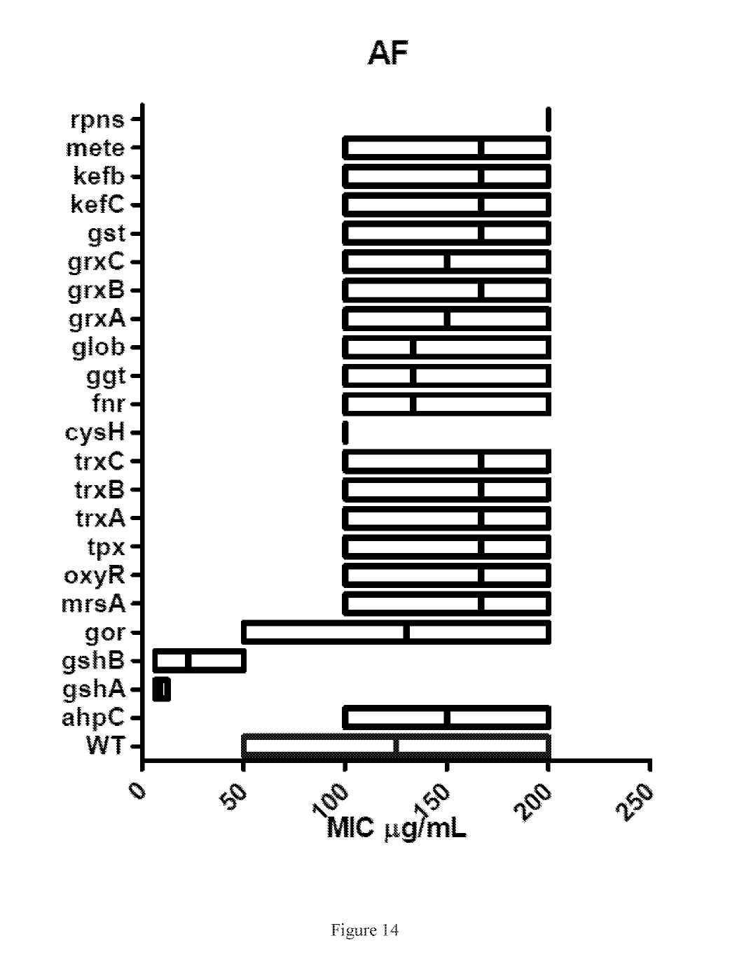

Mutants lacking gsha and gshb were more sensitive to auranofin compared to the wild-type strain (see FIG. 14). By inhibiting the GSH pathway, the Trx pathway has to deal with oxidative stress. Therefore if this pathway is inhibited by auranofin, the bacteria cannot deal with the oxidative stress. This may partially also explain why Gram positive bacteria lacking the GSH pathway such as S. aureus are more susceptible to auranofin compared to Gram negative bacteria. However it is likely that this is not the only mechanism and it is interesting that the gshb mutant was not as sensitive to auranofin as the gsha mutant. Similarly, depletion of gor had little effect

1. A method for reducing the biomass of a biofilm in a subject in need thereof, comprising exposing the biofilm to an effective amount of auranofin.

2. A method for promoting the dispersal of microorganisms from a biofilm in a subject in need thereof, comprising exposing the biofilm to an effective amount of auranofin.

3. The method of claim 2, wherein the biofilm comprises bacteria.

4. (canceled)

5. The method of claim 2, wherein the biofilm comprises at least one of: Gram positive bacteria, bacteria having a thioredoxin (Trx) pathway, bacteria that do not have a glutathione (GSH) and glutathione reductase pathway (GR), and/or bacteria that do not express γ-glutamate-cysteine ligase (GshA), glutathione synthetase (GshB), or glutathione reductase (Gor).

6-7. (canceled)

8. The method of claim 2, wherein the biofilm comprises at least one of: multi-drug resistant bacteria, S. aureus, methicillin-resistant S. aureus (MRSA), A. baumannii, K. pneumoniae, fungi, C. albicans, or C. neoformans.

9-21. (canceled)

22. The method of claim 2, wherein the biofilm is a single species biofilm or a mixed species biofilm.

23. A method for inhibiting biofilm formation in a subject in need thereof, comprising exposing a biofilm-forming microorganism in said subject to an effective amount of auranofin.

24. The method of claim 23, wherein the biofilm-forming microorganism is at least one of a bacterium, a Gram positive bacterium, a bacterium having a thioredoxin (Trx) pathway, a bacterium that does not have a glutathione (GSH) and glutathione reductase pathway (GR), a bacterium that does not have a glutathione (GSH) and glutathione reductase pathway (GR), a multi-drug resistant bacterium, S. aureus, MRSA, A. baumannii, K. pneumoniae, a fungus, C. albicans, or C. neoformans.

25-36. (canceled)

37. The method of claim 23, wherein the auranofin is coated, impregnated or otherwise contacted with a surface or interface susceptible to biofilm formation.

38. The method of claim 37, wherein the surface is a surface of medical or surgical equipment, an implantable medical device or prosthesis.

39. The method of claim 2, wherein the biofilm or biofilm-forming microorganism is on a bodily surface of a subject and exposure of the biofilm or biofilm-forming microorganism to auranofin is by administration of the auranofin to the subject.

40. The method of claim 39, wherein the biofilm or biofilm-forming microorganism is associated with an infection, disease or disorder suffered by the subject or to which the subject is susceptible.

41. The method of claim 2, further comprising exposing the biofilm or biofilm-forming microorganism to at least one additional antimicrobial agent.

42. The method of claim 41, wherein the additional antimicrobial agent is an antibiotic or an anti-fungal agent.

43. The method of claim 42, wherein the antibiotic is selected from rifampicin, gentamicin, erythromycin, lincomycin and vancomycin.

44. A method of sensitizing a microorganism in a biofilm to an antimicrobial agent by exposing the biofilm to an effective amount of auranofin.

45. The method of claim 44, wherein the microorganism is at least one of a bacterium, a Gram positive bacterium, a bacterium having a thioredoxin (Trx) pathway, a bacterium that does not have a glutathione (GSH) and glutathione reductase pathway (GR), a bacterium that does not express γ-glutamate-cysteine ligase (GshA), glutathione synthetase (GshB), and/or glutathione reductase (Gor), a multi-drug resistant bacterium, S. aureus, MRSA, A. baumannii, K. pneumoniae, a fungus, C. albicans, or C. neoformans.

46-57. (canceled)

58. The method of claim 44, wherein the antimicrobial agent is an antibiotic or an antifungal agent.

59. The method of claim 58, wherein the antibiotic is selected from rifampicin, gentamicin, erythromycin, lincomycin and vancomycin.

60-63. (canceled)

64. The method of claim 1, wherein the biofilm comprises at least one of: Gram positive bacteria, multi-drug resistant bacteria, S. aureus, methicillin-resistant S. aureus (MRSA), A. baumannii, K. pneumoniae, a fungi, C. albicans, or C. neoformans.

65. The method of claim 1, wherein the biofilm or biofilm-forming microorganism is on a bodily surface of a subject and exposure of the biofilm or biofilm-forming microorganism to auranofin is by administration of the auranofin to the subject.

66. The method of claim 65, wherein the biofilm or biofilm-forming microorganism is associated with an infection, disease or disorder suffered by the subject or to which the subject is susceptible.

67. The method of claim 1, further comprising exposing the biofilm or biofilm-forming microorganism to at least one additional antimicrobial agent.

68. The method of claim 67, wherein the additional antimicrobial agent is an antibiotic or an anti-fungal agent.

69. The method of claim 68, wherein the antibiotic is selected from rifampicin, gentamicin, erythromycin, lincomycin and vancomycin.
